(19) United States
(12) Patent Application Publication
(10) Pub. No.: US 2026/0045160 A1
(43) Pub. Date: Feb. 12, 2026

(54) WEARABLE ALERT SYSTEM FOR COMMERCIAL VEHICLE

(71) Applicant: Oshkosh Corporation, Oshkosh, WI (US)

(72) Inventors: Jeff Koga, Oshkosh, WI (US); Jon Branson, Oshkosh, WI (US); Amanda Miller, Oshkosh, WI (US)

(73) Assignee: Oshkosh Corporation, Oshkosh, WI (US)

(21) Appl. No.: 19/359,522

(22) Filed: Oct. 15, 2025

Related U.S. Application Data
(63) Continuation of application No. 18/111,119, filed on Feb. 17, 2023, now abandoned.
(60) Provisional application No. 63/325,667, filed on Mar. 31, 2022.

(51) Int. Cl. G08G 1/005; G08B 21/02; G08G 1/16

(52) U.S. Cl. CPC G08G 1/005; G08G 1/166; G08B 21/02

(57) ABSTRACT

A system includes a wearable alert device and processing circuitry. The wearable alert device can be worn by the user of a vehicle and includes a visual alert device configured to provide visual feedback to a user, an aural alert device configured to provide aural feedback to the user, and a haptic alert device configured to provide haptic feedback to the user. The processing circuitry obtains a position of the user of the vehicle and determines an alert condition and a severity of the alert condition based on sensor data obtained from one or more sensors of the vehicle and the position of the user. The processing circuitry operates the visual alert device, the aural alert device, or the haptic alert device to provide visual feedback, aural feedback, or haptic feedback to the user to inform the user regarding the alert condition and the severity of the alert condition.

### CROSS-REFERENCE TO RELATED PATENT APPLICATIONS

The present application is a continuation of U.S. Non-Provisional patent application Ser. No. 18/111,119, filed Feb. 17, 2023, which claims the benefit of and priority to U.S. Provisional Application No. 63/325,667, filed on Mar. 31, 2022, the entire disclosure of which is hereby incorporated by reference herein.

### BACKGROUND

The present disclosure relates generally to vehicles. More specifically, the present disclosure relates to an alert system for a commercial vehicle.

### SUMMARY

One implementation of the present disclosure relates to a system for alerting a user of a vehicle. The system includes a wearable alert device and processing circuitry. The wearable alert device is configured to be worn by the user of the vehicle and includes at least one of a visual alert device configured to provide visual feedback to a user, an aural alert device configured to provide aural feedback to the user, and a haptic alert device configured to provide haptic feedback to the user. The processing circuitry is configured to obtain a current position of the user of the vehicle and determine an alert condition and a severity of the alert condition based on sensor data obtained from one or more sensors of the vehicle and the current position of the user. The processing circuitry is also configured to operate at least one of the visual alert device, the aural alert device, or the haptic alert device to provide visual feedback, aural feedback, or haptic feedback to the user to inform the user regarding the alert condition and the severity of the alert condition.

In one embodiment the wearable alert device is a vest or an article of clothing. In other embodiments, the wearable alert device also includes a positioning device configured to report a position of the user to the processing circuitry.

In some embodiments the processing circuitry is further configured to determine, based on the current position of the user of the vehicle, whether the user is currently within a zone of an implement of the vehicle or in a path of the implement of the vehicle, and determine the alert condition and the severity of the alert condition at least in part based on the determination of whether the user is currently within the zone of the implement of the vehicle or in the path of the implement of the vehicle.

In some embodiments, the implement of the vehicle comprises an automated side-loading arm, a front-end loader, a tailgate, a mixer chute, a ladder assembly, or a boom assembly.

In some embodiments, the alert condition comprises at least one of the following conditions: the user is located within a zone of an implement of the vehicle, the user is located in a path of the implement of the vehicle, the user is within a cab of the vehicle and traffic is oncoming, a rear-end collision is predicted to occur, or a side collision is predicted to occur.

In some embodiments, the processing circuitry is configured further to, upon determining the alert condition is of high severity, operate the visual alert device to provide visual feedback, operate the aural alert device to provide aural feedback, and operate the haptic alert device to provide haptic feedback to inform the user of the high severity of the alert condition. In some embodiments, the processing circuitry is configured further to, upon determining the alert condition is of medium severity, operate the visual alert device to provide visual feedback and operate the aural alert device to provide aural feedback to inform the user of the medium severity of the alert condition. In some embodiments, the processing circuitry is configured further to, upon determining the alert condition is of low severity, operate the visual alert device to provide visual feedback to inform the user of the low severity of the alert condition.

Another implementation of the present disclosure relates to a method for alerting a user of a vehicle regarding an alert condition, the method comprising obtaining a current position of the user of the vehicle, determining an alert condition and a severity of the alert condition based on sensor data obtained from one or more sensors of the vehicle and the current position of the user. In some embodiments, the method includes operating at least one of a visual alert device to provide visual feedback, an aural alert device to provide aural feedback, or a haptic alert device to provide haptic feedback to the user to inform the user regarding the alert condition and the severity of the alert condition.

In some embodiments, the visual alert device, the aural alert device, or the haptic alert device is provided on a vest or article of clothing that is worn by the user. In some embodiments, the method further comprises reporting, by a positioning device, the current position of the user to a processing circuitry.

In some embodiments, the method includes determining, based on the current position of the user of the vehicle, whether the user is currently within a zone of an implement of the vehicle or in a path of the implement of the vehicle, and determining the alert condition and the severity of the alert condition at least in part based on the determination of whether the user is currently within the zone of the implement of the vehicle or in the path of the implement of the vehicle.

In some embodiments, the implement of the vehicle comprises an automated side-loading arm, a front-end loader, a tailgate, a mixer chute, a ladder assembly, or a boom assembly.

In other embodiments, the alert condition comprises at least one of the following conditions: the user is located within a zone of an implement of the vehicle, the user is located in a path of the implement of the vehicle, the user is within a cab of the vehicle and traffic is oncoming, a rear-end collision is predicted to occur, or a side collision is predicted to occur.

In some embodiments, the method includes, upon determining the alert condition is of high severity, operating the visual alert device to provide visual feedback, operating the aural alert device to provide aural feedback, and operating the haptic alert device to provide haptic feedback to inform the user of the high severity of the alert condition. In some embodiments, the method includes, upon determining the alert condition is of medium severity, operating the visual alert device to provide visual feedback and operating the aural alert device to provide aural feedback to inform the user of the medium severity of the alert condition. In some embodiments, the method includes, upon determining the alert condition is of low severity, operating the visual alert device to provide visual feedback to inform the user of the low severity of the alert condition.

Another implementation of the present disclosure relates to a wearable alert device. In some embodiments, the wearable alert device comprises an article of clothing with at least one of a visual alert device provided on the article of clothing and configured to provide visual feedback to a user, an aural alert device provided on the article of clothing and configured to provide aural feedback to the user, or a haptic alert device provided on the article of clothing and configured to provide haptic feedback to the user. In some embodiments, the wearable alert device also includes processing circuitry configured to obtain a current position of the user, determine an alert condition and a severity of the alert condition based on sensor data obtained from one or more sensors of a vehicle and the current position of the user, and operate at least one of the visual alert device, the aural alert device, or the haptic alert device to provide visual feedback, aural feedback, or haptic feedback to the user to inform the user regarding the alert condition and the severity of the alert condition.

In some embodiments, the article of clothing is a vest. In some embodiments, the wearable alert device also comprises a positioning device configured to report a position of the user to the processing circuitry. In some embodiments, the processing circuitry is further configured to determine, based on the current position of the user of the vehicle, whether the user is currently within a zone of an implement of the vehicle or in a path of the implement of the vehicle. In other embodiments, the processing circuitry is configured to determine the alert condition and the severity of the alert condition at least in part based on the determination of whether the user is currently within the zone of the implement of the vehicle or in the path of the implement of the vehicle.

In some embodiments, the alert condition comprises at least one of the following conditions: the user is located within a zone of an implement of the vehicle, the user is located in a path of the implement of the vehicle, the user is within a cab of the vehicle and traffic is oncoming, a rear-end collision is predicted to occur, or a side collision is predicted to occur.

In some embodiments, the processing circuitry is further configured to, upon determining the alert condition is of high severity, operate the visual alert device to provide visual feedback, operate the aural alert device to provide aural feedback, and operate the haptic alert device to provide haptic feedback to inform the user of the high severity of the alert condition. In some embodiments, the processing circuitry is configured to, upon determining the alert condition is of medium severity, operate the visual alert device to provide visual feedback and operate the aural alert device to provide aural feedback to inform the user of the medium severity of the alert condition. In some embodiments, the processing circuitry is configured to, upon determining the alert condition is of low severity, operate the visual alert device to provide visual feedback to inform the user of the low severity of the alert condition.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a left-side view of a vehicle, according to an exemplary embodiment.

FIG. 2 is a perspective view of a chassis of the vehicle of FIG. 1.

FIG. 3 is a perspective view of the vehicle of FIG. 1 configured as a front-loading refuse vehicle, according to an exemplary embodiment.

FIG. 4 is a left-side view of the front-loading refuse vehicle of FIG. 3 configured with a tag axle.

FIG. 5 is a perspective view of the vehicle of FIG. 1 configured as a side-loading refuse vehicle, according to an exemplary embodiment.

FIG. 6 is a right-side view of the side-loading refuse vehicle of FIG. 5.

FIG. 7 is a top view of the side-loading refuse vehicle of FIG. 5.

FIG. 8 is a left-side view of the side-loading refuse vehicle of FIG. 5 configured with a tag axle.

FIG. 9 is a perspective view of the vehicle of FIG. 1 configured as a mixer vehicle, according to an exemplary embodiment.

FIG. 10 is a perspective view of the vehicle of FIG. 1 configured as a fire fighting vehicle, according to an exemplary embodiment.

FIG. 11 is a left-side view of the vehicle of FIG. 1 configured as an airport fire fighting vehicle, according to an exemplary embodiment.

FIG. 12 is a perspective view of the vehicle of FIG. 1 configured as a boom lift, according to an exemplary embodiment.

FIG. 13 is a perspective view of the vehicle of FIG. 1 configured as a scissor lift, according to an exemplary embodiment.

FIG. 14 is a diagram of a wearable alert device for use with a vehicle, according to an exemplary embodiment.

FIG. 15 is a top view of a vehicle illustrating a first alert condition for the wearable alert device of FIG. 14, according to an exemplary embodiment.

FIG. 16 is a top view of a vehicle illustrating a second alert condition for the wearable alert device of FIG. 14, according to an exemplary embodiment.

FIG. 17 is top view of a vehicle illustrating a third alert condition for the wearable alert device of FIG. 14, according to an exemplary embodiment.

FIG. 18 is a top view of a vehicle illustrating a fourth alert condition for the wearable alert device of FIG. 14, according to an exemplary embodiment.

FIG. 19 is a top view of a vehicle illustrating a fifth alert condition for the wearable alert device of FIG. 14, according to an exemplary embodiment.

FIG. 20 is a block diagram of a control system for the vehicle and the wearable alert device of FIG. 14, according to an exemplary embodiment.

FIG. 21 is a diagram of a graphical user interface for modifying alert settings of the wearable alert device, according to an exemplary embodiment.

FIG. 22 is a flow diagram of a process for providing alerts using a wearable alert device, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a vehicle includes a system for notifying an operator regarding an alert condition. The system includes a wearable alert device that can have the form of a vest and is worn by the user. The wearable alert device includes visual alert devices, aural alert devices, and haptic feedback devices. The wearable alert device also includes a positioning device configured to report the user's position as the user or operator moves about the vehicle or is inside of the vehicle. An alert condition can be identified based on sensor data from sensors of the vehicle and based on the user's position. The wearable alert device provides any combination of visual, aural, or haptic feedback to notify the user regarding the alert condition and/or a severity of the alert condition.

### Overall Vehicle

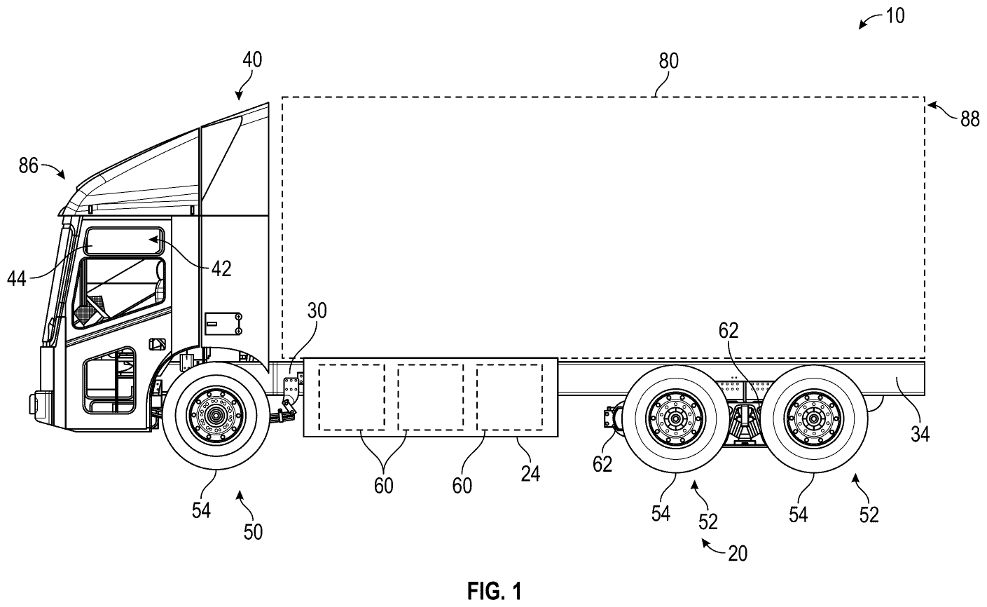

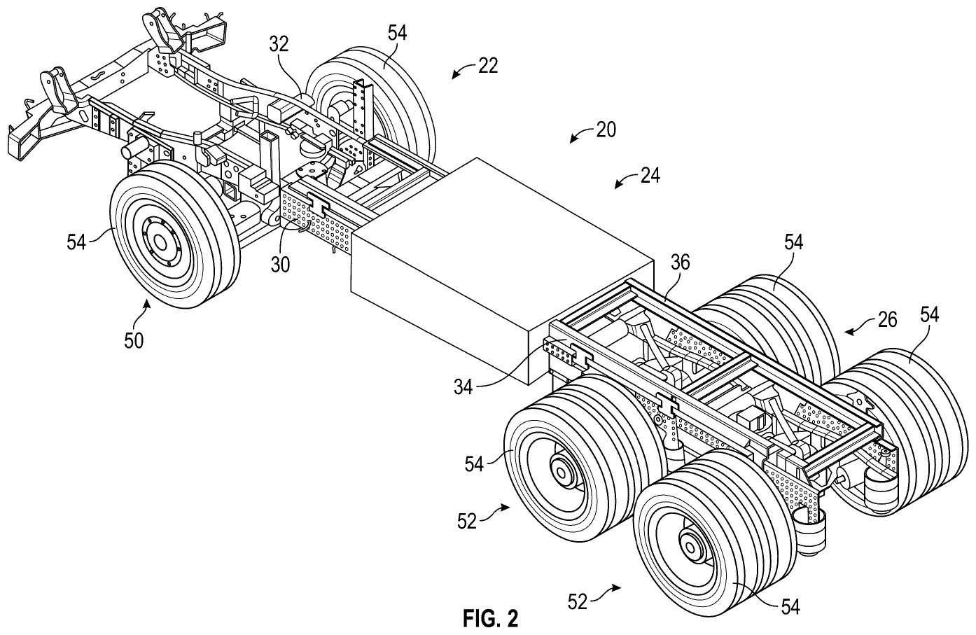

Referring to FIGS. 1 and 2, a reconfigurable vehicle (e.g., a vehicle assembly, a truck, a vehicle base, etc.) is shown as vehicle 10, according to an exemplary embodiment. As shown, the vehicle 10 includes a frame assembly or chassis assembly, shown as chassis 20, that supports other components of the vehicle 10. The chassis 20 extends longitudinally along a length of the vehicle 10, substantially parallel to a primary direction of travel of the vehicle 10. As shown, the chassis 20 includes three sections or portions, shown as front section 22, middle section 24, and rear section 26. The middle section 24 of the chassis 20 extends between the front section 22 and the rear section 26. In some embodiments, the middle section 24 of the chassis 20 couples the front section 22 to the rear section 26. In other embodiments, the front section 22 is coupled to the rear section 26 by another component (e.g., the body of the vehicle 10).

As shown in FIG. 2, the front section 22 includes a pair of frame portions, frame members, or frame rails, shown as front rail portion 30 and front rail portion 32. The rear section 26 includes a pair of frame portions, frame members, or frame rails, shown as rear rail portion 34 and rear rail portion 36. The front rail portion 30 is laterally offset from the front rail portion 32. Similarly, the rear rail portion 34 is laterally offset from the rear rail portion 36. This spacing may provide frame stiffness and space for vehicle components (e.g., batteries, motors, axles, gears, etc.) between the frame rails. In some embodiments, the front rail portions 30 and 32 and the rear rail portions 34 and 36 extend longitudinally and substantially parallel to one another. The chassis 20 may include additional structural elements (e.g., cross members that extend between and couple the frame rails).

In some embodiments, the front section 22 and the rear section 26 are configured as separate, discrete subframes (e.g., a front subframe and a rear subframe). In such embodiments, the front rail portion 30, the front rail portion 32, the rear rail portion 34, and the rear rail portion 36 are separate, discrete frame rails that are spaced apart from one another. In some embodiments, the front section 22 and the rear section 26 are each directly coupled to the middle section 24 such that the middle section 24 couples the front section 22 to the rear section 26. Accordingly, the middle section 24 may include a structural housing or frame. In other embodiments, the front section 22, the middle section 24, and the rear section 26 are coupled to one another by another component, such as a body of the vehicle 10.

In other embodiments, the front section 22, the middle section 24, and the rear section 26 are defined by a pair of frame rails that extend continuously along the entire length of the vehicle 10. In such an embodiment, the front rail portion 30 and the rear rail portion 34 would be front and rear portions of a first frame rail, and the front rail portion 32 and the rear rail portion 36 would be front and rear portions of a second frame rail. In such embodiments, the middle section 24 would include a center portion of each frame rail.

In some embodiments, the middle section 24 acts as a storage portion that includes one or more vehicle components. The middle section 24 may include an enclosure that contains one or more vehicle components and/or a frame that supports one or more vehicle components. By way of example, the middle section 24 may contain or include one or more electrical energy storage devices (e.g., batteries, capacitors, etc.). By way of another example, the middle section 24 may include fuel tanks. By way of yet another example, the middle section 24 may define a void space or storage volume that can be filled by a user.

A cabin, operator compartment, or body component, shown as cab 40, is coupled to a front end portion of the chassis 20 (e.g., the front section 22 of the chassis 20). Together, the chassis 20 and the cab 40 define a front end of the vehicle 10. The cab 40 extends above the chassis 20. The cab 40 includes an enclosure or main body that defines an interior volume, shown as cab interior 42, that is sized to contain one or more operators. The cab 40 also includes one or more doors 44 that facilitate selective access to the cab interior 42 from outside of the vehicle 10. The cab interior 42 contains one or more components that facilitate operation of the vehicle 10 by the operator. By way of example, the cab interior 42 may contain components that facilitate operator comfort (e.g., seats, seatbelts, etc.), user interface components that receive inputs from the operators (e.g., steering wheels, pedals, touch screens, switches, buttons, levers, etc.), and/or user interface components that provide information to the operators (e.g., lights, gauges, speakers, etc.). The user interface components within the cab 40 may facilitate operator control over the drive components of the vehicle 10 and/or over any implements of the vehicle 10.

The vehicle 10 further includes a series of axle assemblies, shown as front axle 50 and rear axles 52. As shown, the vehicle 10 includes one front axle 50 coupled to the front section 22 of the chassis 20 and two rear axles 52 each coupled to the rear section 26 of the chassis 20. In other embodiments, the vehicle 10 includes more or fewer axles. By way of example, the vehicle 10 may include a tag axle that may be raised or lowered to accommodate variations in weight being carried by the vehicle 10. The front axle 50 and the rear axles 52 each include a series of tractive elements (e.g., wheels, treads, etc.), shown as wheel and tire assemblies 54. The wheel and tire assemblies 54 are configured to engage a support surface (e.g., roads, the ground, etc.) to support and propel the vehicle 10. The front axle 50 and the rear axles 52 may include steering components (e.g., steering arms, steering actuators, etc.), suspension components (e.g., gas springs, dampeners, air springs, etc.), power transmission or drive components (e.g., differentials, drive shafts, etc.), braking components (e.g., brake actuators, brake pads, brake discs, brake drums, etc.), and/or other components that facilitate propulsion or support of the vehicle.

In some embodiments, the vehicle 10 is configured as an electric vehicle that is propelled by an electric powertrain system. Referring to FIG. 1, the vehicle 10 includes one or more electrical energy storage devices (e.g., batteries, capacitors, etc.), shown as batteries 60. As shown, the batteries 60 are positioned within the middle section 24 of the chassis 20. In other embodiments, the batteries 60 are otherwise positioned throughout the vehicle 10. The vehicle 10 further includes one or more electromagnetic devices or prime movers (e.g., motor/generators), shown as drive motors 62. The drive motors 62 are electrically coupled to the batteries 60. The drive motors 62 may be configured to receive electrical energy from the batteries 60 and provide rotational mechanical energy to the wheel and tire assemblies 54 to propel the vehicle 10. The drive motors 62 may be configured to receive rotational mechanical energy from the wheel and tire assemblies 64 and provide electrical energy to the batteries 60, providing a braking force to slow the vehicle 10.

The batteries 60 may include one or more rechargeable batteries (e.g., lithium-ion batteries, nickel-metal hydride batteries, lithium-ion polymer batteries, lead-acid batteries, nickel-cadmium batteries, etc.). The batteries 60 may be charged by one or more sources of electrical energy onboard the vehicle 10 (e.g., solar panels, etc.) or separate from the vehicle 10 (e.g., connections to an electrical power grid, a wireless charging system, etc.). As shown, the drive motors 62 are positioned within the rear axles 52 (e.g., as part of a combined axle and motor assembly). In other embodiments, the drive motors 62 are otherwise positioned within the vehicle 10.

In other embodiments, the vehicle 10 is configured as a hybrid vehicle that is propelled by a hybrid powertrain system (e.g., a diesel/electric hybrid, gasoline/electric hybrid, natural gas/electric hybrid, etc.). According to an exemplary embodiment, the hybrid powertrain system may include a primary driver (e.g., an engine, a motor, etc.), an energy generation device (e.g., a generator, etc.), and/or an energy storage device (e.g., a battery, capacitors, ultra-capacitors, etc.) electrically coupled to the energy generation device. The primary driver may combust fuel (e.g., gasoline, diesel, etc.) to provide mechanical energy, which a transmission may receive and provide to the front axle 50 and/or the rear axles 52 to propel the vehicle 10. Additionally or alternatively, the primary driver may provide mechanical energy to the generator, which converts the mechanical energy into electrical energy. The electrical energy may be stored in the energy storage device (e.g., the batteries 60) in order to later be provided to a motive driver.

In yet other embodiments, the chassis 20 may further be configured to support non-hybrid powertrains. For example, the powertrain system may include a primary driver that is a compression-ignition internal combustion engine that utilizes diesel fuel.

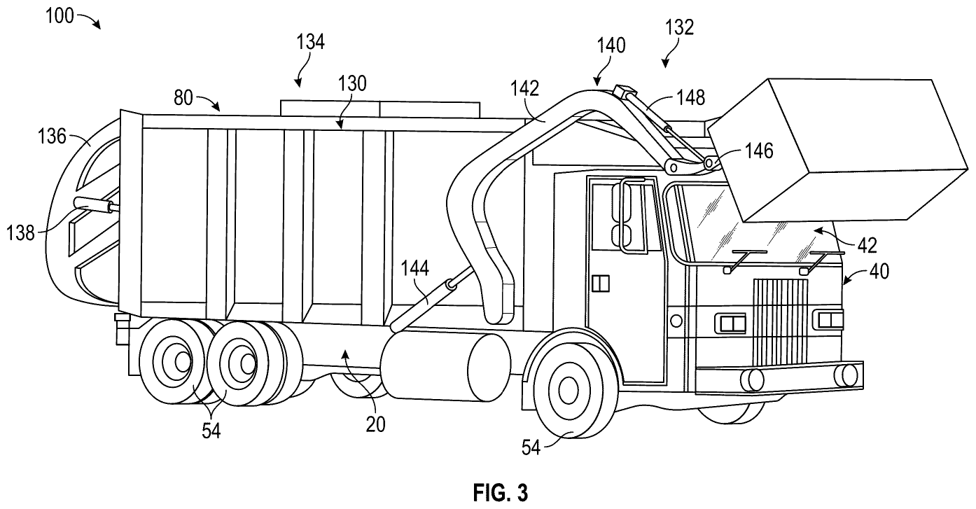

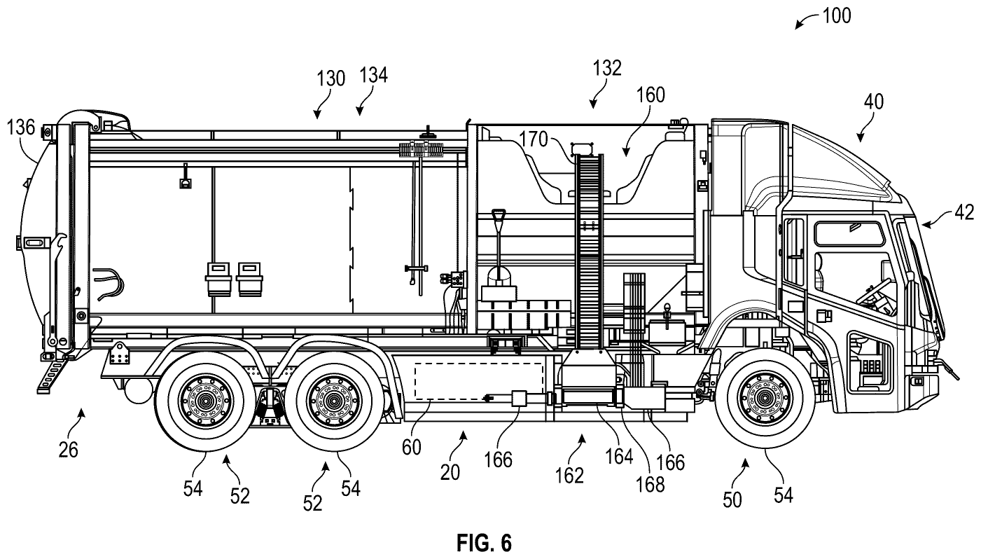

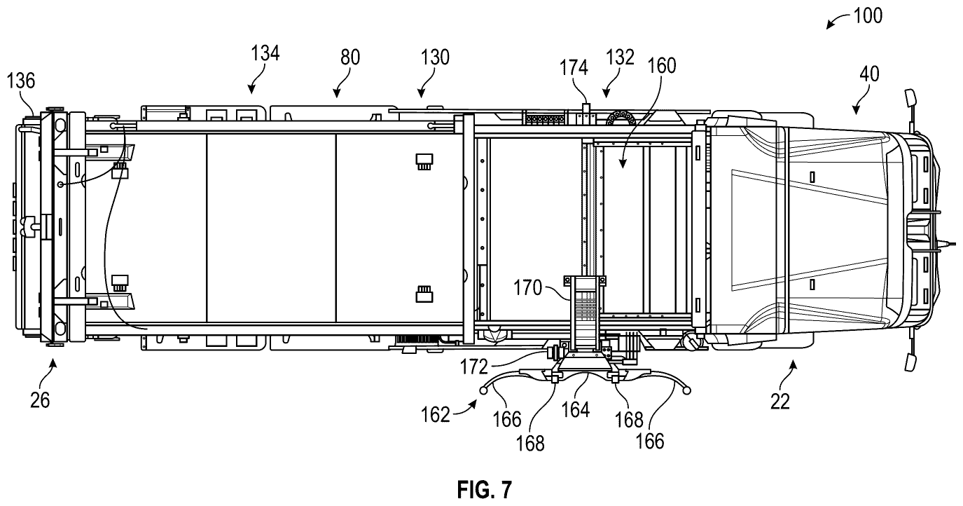

Referring to FIG. 1, the vehicle 10 includes a rear assembly, module, implement, body, or cargo area, shown as application kit 80. The application kit 80 may include one or more implements, vehicle bodies, and/or other components. Although the application kit 80 is shown positioned behind the cab 40, in other embodiments the application kit 80 extends forward of the cab 40. The vehicle 10 may be outfitted with a variety of different application kits 80 to configure the vehicle 10 for use in different applications. Accordingly, a common vehicle 10 can be configured for a variety of different uses simply by selecting an appropriate application kit 80. By way of example, the vehicle 10 may be configured as a refuse vehicle, a concrete mixer, a fire fighting vehicle, an airport fire fighting vehicle, a lift device (e.g., a boom lift, a scissor lift, a telehandler, a vertical lift, etc.), a crane, a tow truck, a military vehicle, a delivery vehicle, a mail vehicle, a boom truck, a plow truck, a farming machine or vehicle, a construction machine or vehicle, a coach bus, a school bus, a semi-truck, a passenger or work vehicle (e.g., a sedan, a SUV, a truck, a van, etc.), and/or still another vehicle. FIGS. 3-13 illustrate various examples of how the vehicle 10 may be configured for specific applications. Although only a certain set of vehicle configurations is shown, it should be understood that the vehicle 10 may be configured for use in other applications that are not shown.

The application kit 80 may include various actuators to facilitate certain functions of the vehicle 10. By way of example, the application kit 80 may include hydraulic actuators (e.g., hydraulic cylinders, hydraulic motors, etc.), pneumatic actuators (e.g., pneumatic cylinders, pneumatic motors, etc.), and/or electrical actuators (e.g., electric motors, electric linear actuators, etc.). The application kit 80 may include components that facilitate operation of and/or control of these actuators. By way of example, the application kit 80 may include hydraulic or pneumatic components that form a hydraulic or pneumatic circuit (e.g., conduits, valves, pumps, compressors, gauges, reservoirs, accumulators, etc.). By way of another example, the application kit 80 may include electrical components (e.g., batteries, capacitors, voltage regulators, motor controllers, etc.). The actuators may be powered by components of the vehicle 10. By way of example, the actuators may be powered by the batteries 60, the drive motors 62, or the primary driver (e.g., through a power take off).

The vehicle 10 generally extends longitudinally from a front side 86 to a rear side 88. The front side 86 is defined by the cab 40 and/or the chassis. The rear side 88 is defined by the application kit 80 and/or the chassis 20. The primary, forward direction of travel of the vehicle 10 is longitudinal, with the front side 86 being arranged forward of the rear side 88.

### Front-Loading Refuse Vehicle

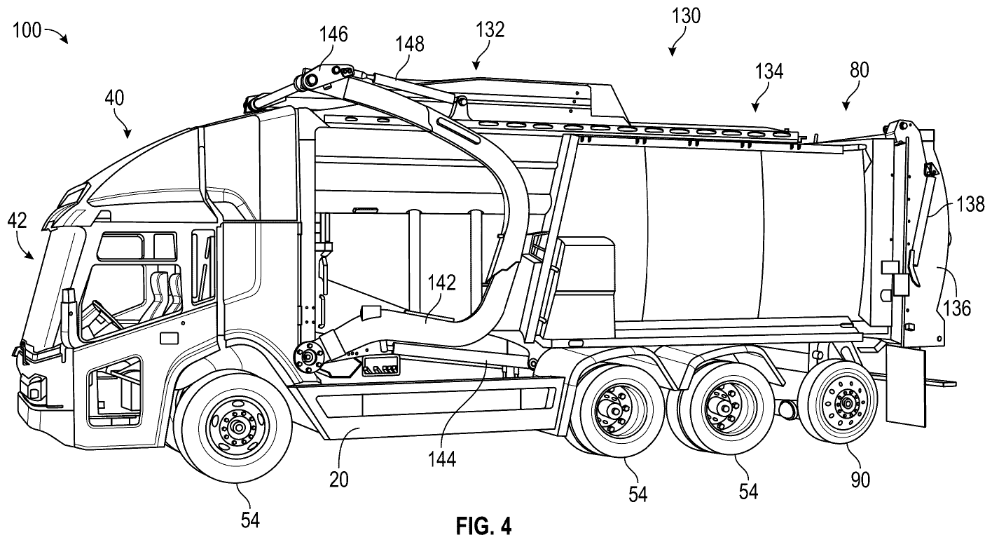

Referring now to FIGS. 3 and 4, the vehicle 10 is configured as a refuse vehicle 100 (e.g., a refuse truck, a garbage truck, a waste collection truck, a sanitation truck, a recycling truck, etc.). Specifically, the refuse vehicle 100 is a front-loading refuse vehicle. In other embodiments, the refuse vehicle 100 is configured as a rear-loading refuse vehicle or a front-loading refuse vehicle. The refuse vehicle 100 may be configured to transport refuse from various waste receptacles (e.g., refuse containers) within a municipality to a storage and/or processing facility (e.g., a landfill, an incineration facility, a recycling facility, etc.).

FIG. 4 illustrates the refuse vehicle 100 of FIG. 3 configured with a liftable axle, shown as tag axle 90, including a pair of wheel and tire assemblies 54. As shown, the tag axle 90 is positioned reward of the rear axles 52. The tag axle 90 can be selectively raised and lowered (e.g., by a hydraulic actuator) to selectively engage the wheel and tire assemblies 54 of the tag axle 90 with the ground. The tag axle 90 may be raised to reduce rolling resistance experienced by the refuse vehicle 100. The tag axle 90 may be lowered to distribute the loaded weight of the vehicle 100 across a greater number of a wheel and tire assemblies 54 (e.g., when the refuse vehicle 100 is loaded with refuse).

As shown in FIGS. 3 and 4, the application kit 80 of the refuse vehicle 100 includes a series of panels that form a rear body or container, shown as refuse compartment 130. The refuse compartment 130 may facilitate transporting refuse from various waste receptacles within a municipality to a storage and/or a processing facility (e.g., a landfill, an incineration facility, a recycling facility, etc.). By way of example, loose refuse may be placed into the refuse compartment 130 where it may be compacted (e.g., by a packer system within the refuse compartment 130). The refuse compartment 130 may also provide temporary storage for refuse during transport to a waste disposal site and/or a recycling facility. In some embodiments, the refuse compartment 130 may define a hopper volume 132 and storage volume 134. In this regard, refuse may be initially loaded into the hopper volume 132 and later compacted into the storage volume 134. As shown, the hopper volume 132 is positioned between the storage volume 134 and the cab 40 (e.g., refuse is loaded into a portion of the refuse compartment 130 behind the cab 40 and stored in a portion further toward the rear of the refuse compartment 130). In other embodiments, the storage volume may be positioned between the hopper volume and the cab 40 (e.g., in a rear-loading refuse truck, etc.). The application kit 80 of the refuse vehicle 100 further includes a pivotable rear portion, shown as tailgate 136, that is pivotally coupled to the refuse compartment 130. The tailgate 136 may be selectively repositionable between a closed position and an open position by an actuator (e.g., a hydraulic cylinder, an electric linear actuator, etc.), shown as tailgate actuator 138 (e.g., to facilitate emptying the storage volume).

As shown in FIGS. 3 and 4, the refuse vehicle 100 also includes an implement, shown as lift assembly 140, which is a front-loading lift assembly. According to an exemplary embodiment, the lift assembly 140 includes a pair of lift arms 142 and a pair of actuators (e.g., hydraulic cylinders, electric linear actuators, etc.), shown as lift arm actuators 144. The lift arms 142 may be rotatably coupled to the chassis 20 and/or the refuse compartment 130 on each side of the refuse vehicle 100 (e.g., through a pivot, a lug, a shaft, etc.), such that the lift assembly 140 may extend forward relative to the cab 40 (e.g., a front-loading refuse truck, etc.). In other embodiments, the lift assembly 140 may extend rearward relative to the application kit 80 (e.g., a rear-loading refuse truck). As shown in FIGS. 3 and 4, in an exemplary embodiment the lift arm actuators 144 may be positioned such that extension and retraction of the lift arm actuators 144 rotates the lift arms 142 about an axis extending through the pivot. In this regard, the lift arms 142 may be rotated by the lift arm actuators 144 to lift a refuse container over the cab 40. The lift assembly 140 further includes a pair of interface members, shown as lift forks 146, each pivotally coupled to a distal end of one of the lift arms 142. The lift forks 146 may be configured to engage a refuse container (e.g., a dumpster) to selectively couple the refuse container to the lift arms 142. By way of example, each of the lift forks 146 may be received within a corresponding pocket defined by the refuse container. A pair of actuators (e.g., hydraulic cylinders, electric linear actuators, etc.), shown as articulation actuators 148, are each coupled to one of the lift arms 142 and one of the lift forks 146. The articulation actuators 148 may be positioned to rotate the lift forks 146 relative to the lift arms 142 about a horizontal axis. Accordingly, the articulation actuators 148 may assist in tipping refuse out of the refuse container and into the refuse compartment 130. The lift arm actuators 144 may then rotate the lift arms 142 to return the empty refuse container to the ground.

### Side-Loading Refuse Vehicle

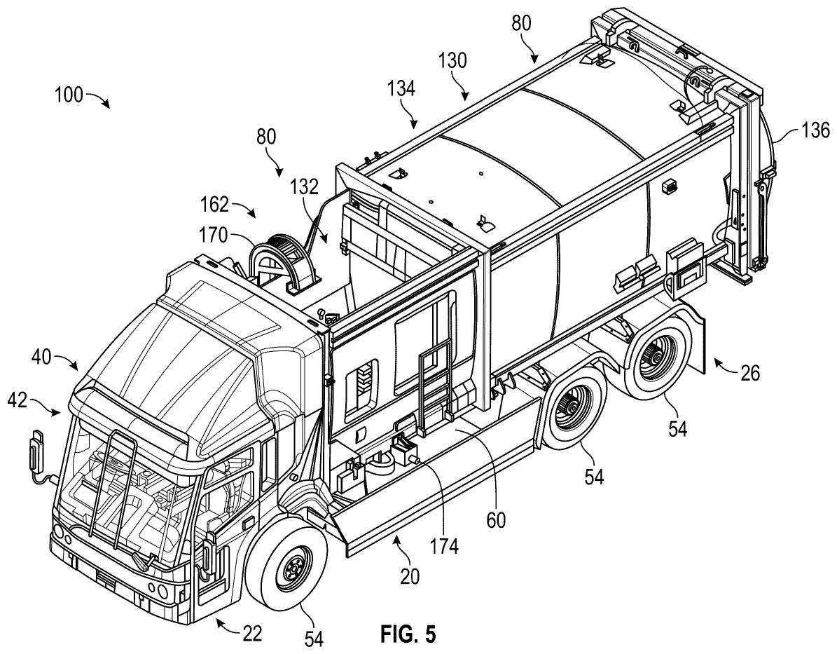

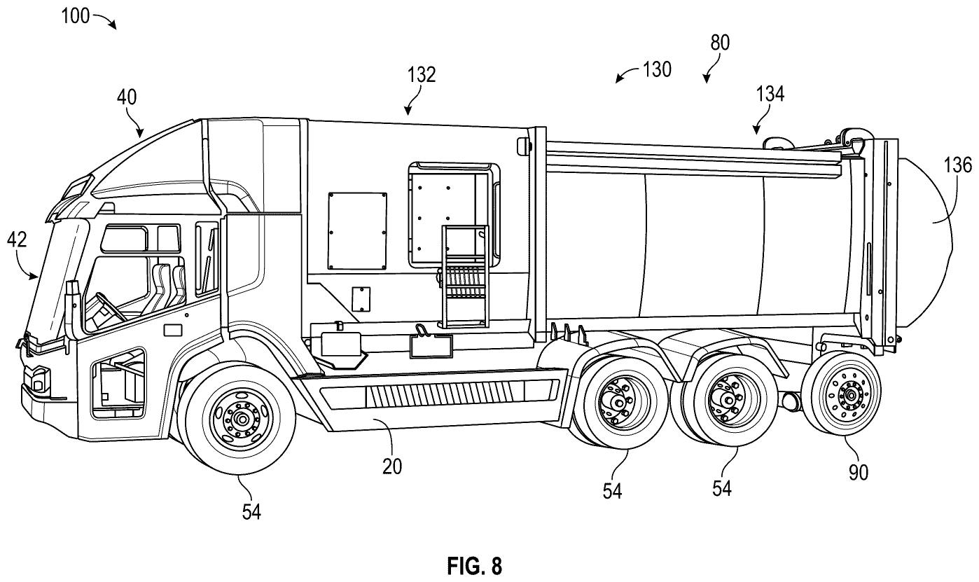

Referring now to FIGS. 5-8, an alternative configuration of the refuse vehicle 100 is shown according to an exemplary embodiment. Specifically, the refuse vehicle 100 of FIGS. 5-8 is configured as a side-loading refuse vehicle. The refuse vehicle 100 of FIGS. 5-8 may be substantially similar to the front-loading refuse vehicle 100 of FIGS. 3 and 4 except as otherwise specified herein. As shown in FIG. 8, the refuse vehicle 100 of FIGS. 5-7 may be configured with a tag axle 90.

Referring still to FIGS. 5-8, the refuse vehicle 100 omits the lift assembly 140 and instead includes a side-loading lift assembly, shown as lift assembly 160, that extends laterally outward from a side of the refuse vehicle 100. The lift assembly 160 includes an interface assembly, shown as grabber assembly 162, that is configured to engage a refuse container (e.g., a residential garbage can) to selectively couple the refuse container to the lift assembly 160. The grabber assembly 162 includes a main portion, shown as main body 164, and a pair of fingers or interface members, shown as grabber fingers 166. The grabber fingers 166 are pivotally coupled to the main body 164 such that the grabber fingers 166 are each rotatable about a vertical axis. A pair of actuators (e.g., hydraulic motors, electric motors, etc.), shown as finger actuators 168, are configured to control movement of the grabber fingers 166 relative to the main body 164.

The grabber assembly 162 is movably coupled to a guide, shown as track 170, that extends vertically along a side of the refuse vehicle 100. Specifically, the main body 164 is slidably coupled to the track 170 such that the main body 164 is repositionable along a length of the track 170. An actuator (e.g., a hydraulic motor, an electric motor, etc.), shown as lift actuator 172, is configured to control movement of the grabber assembly 162 along the length of the track 170. In some embodiments, a bottom end portion of the track 170 is straight and substantially vertical such that the grabber assembly 162 raises or lowers a refuse container when moving along the bottom end portion of the track 170. In some embodiments, a top end portion of the track 170 is curved such that the grabber assembly 162 inverts a refuse container to dump refuse into the hopper volume 132 when moving along the top end portion of the track 170.

The lift assembly 160 further includes an actuator (e.g., a hydraulic cylinder, an electric linear actuator, etc.), shown as track actuator 174, that is configured to control lateral movement of the grabber assembly 162. By way of example, the track actuator 174 may be coupled to the chassis 20 and the track 170 such that the track actuator 174 moves the track 170 and the grabber assembly 162 laterally relative to the chassis 20. The track actuator 174 may facilitate repositioning the grabber assembly 162 to pick up and replace refuse containers that are spaced laterally outward from the refuse vehicle 100.

### Concrete Mixer Truck

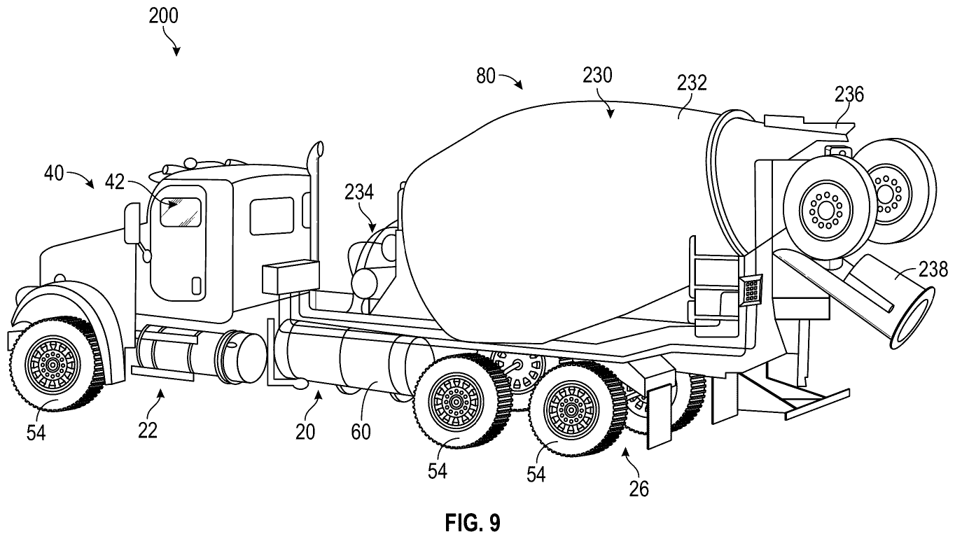

Referring now to FIG. 9, the vehicle 10 is configured as a mixer truck (e.g., a concrete mixer truck, a mixer vehicle, etc.), shown as mixer truck 200. Specifically, the mixer truck 200 is shown as a rear-discharge concrete mixer truck. In other embodiments, the mixer truck 200 is a front-discharge concrete mixer truck.

As shown in FIG. 9, the application kit 80 includes a mixing drum assembly (e.g., a concrete mixing drum), shown as drum assembly 230. The drum assembly 230 may include a mixing drum 232, a drum drive system 234 (e.g., a rotational actuator or motor, such as an electric motor or hydraulic motor), an inlet portion, shown as hopper 236, and an outlet portion, shown as chute 238. The mixing drum 232 may be coupled to the chassis 20 and may be disposed behind the cab 40 (e.g., at the rear and/or middle of the chassis 20). In an exemplary embodiment, the drum drive system 234 is coupled to the chassis 20 and configured to selectively rotate the mixing drum 232 about a central, longitudinal axis. According to an exemplary embodiment, the central, longitudinal axis of the mixing drum 232 may be elevated from the chassis 20 (e.g., from a horizontal plane extending along the chassis 20) at an angle in the range of five degrees to twenty degrees. In other embodiments, the central, longitudinal axis may be elevated by less than five degrees (e.g., four degrees, etc.). In yet another embodiment, the mixer truck 200 may include an actuator positioned to facilitate adjusting the central, longitudinal axis to a desired or target angle (e.g., manually in response to an operator input/command, automatically according to a control system, etc.).

The mixing drum 232 may be configured to receive a mixture, such as a concrete mixture (e.g., cementitious material, aggregate, sand, etc.), through the hopper 236. In some embodiments, the mixer truck 200 includes an injection system (e.g., a series of nozzles, hoses, and/or valves) including an injection valve that selectively fluidly couples a supply of fluid to the inner volume of the mixing drum 232. By way of example, the injection system may be used to inject water and/or chemicals (e.g., air entrainers, water reducers, set retarders, set accelerators, superplasticizers, corrosion inhibitors, coloring, calcium chloride, minerals, and/or other concrete additives, etc.) into the mixing drum 232. The injection valve may facilitate injecting water and/or chemicals from a fluid reservoir (e.g., a water tank, etc.) into the mixing drum 232, while preventing the mixture in the mixing drum 232 from exiting the mixing drum 232 through the injection system. In some embodiments, one or more mixing elements (e.g., fins, etc.) may be positioned in the interior of the mixing drum 232, and may be configured to agitate the contents of the mixture when the mixing drum 232 is rotated in a first direction (e.g., counterclockwise, clockwise, etc.), and drive the mixture out through the chute 238 when the mixing drum 232 is rotated in a second direction (e.g., clockwise, counterclockwise, etc.). In some embodiments, the chute 238 may also include an actuator positioned such that the chute 238 may be selectively pivotable to position the chute 238 (e.g., vertically, laterally, etc.), for example at an angle at which the mixture is expelled from the mixing drum 232.

### Fire Truck

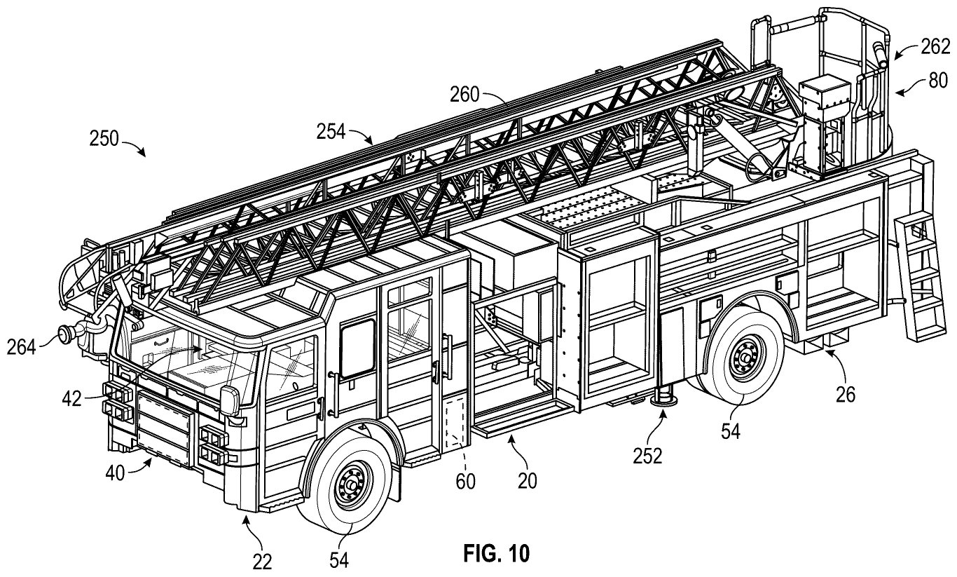

Referring now to FIG. 10, the vehicle 10 is configured as a fire fighting vehicle, fire truck, or fire apparatus (e.g., a turntable ladder truck, a pumper truck, a quint, etc.), shown as fire fighting vehicle 250. In the embodiment shown in FIG. 10, the fire fighting vehicle 250 is configured as a rear-mount aerial ladder truck. In other embodiments, the fire fighting vehicle 250 is configured as a mid-mount aerial ladder truck, a quint fire truck (e.g., including an on-board water storage, a hose storage, a water pump, etc.), a tiller fire truck, a pumper truck (e.g., without an aerial ladder), or another type of response vehicle. By way of example, the vehicle 10 may be configured as a police vehicle, an ambulance, a tow truck, or still other vehicles used for responding to a scene (e.g., an accident, a fire, an incident, etc.).

As shown in FIG. 10, in the fire fighting vehicle 250, the application kit 80 is positioned mainly rearward from the cab 40. The application kit 80 includes deployable stabilizers (e.g., outriggers, downriggers, etc.), shown as outriggers 252, that are coupled to the chassis 20. The outriggers 252 may be configured to selectively extend from each lateral side and/or the rear of the fire fighting vehicle 250 and engage a support surface (e.g., the ground) in order to provide increased stability while the fire fighting vehicle 250 is stationary. The fire fighting vehicle 250 further includes an extendable or telescoping ladder assembly, shown as ladder assembly 254. The increased stability provided by the outriggers 252 is desirable when the ladder assembly 254 is in use (e.g., extended from the fire fighting vehicle 250) to prevent tipping. In some embodiments, the application kit 80 further includes various storage compartments (e.g., cabinets, lockers, etc.) that may be selectively opened and/or accessed for storage and/or component inspection, maintenance, and/or replacement.

As shown in FIG. 10, the ladder assembly 254 includes a series of ladder sections 260 that are slidably coupled with one another such that the ladder sections 260 may extend and/or retract (e.g., telescope) relative to one another to selectively vary a length of the ladder assembly 254. A base platform, shown as turntable 262, is rotatably coupled to the chassis 20 and to a proximal end of a base ladder section 260 (i.e., the most proximal of the ladder sections 260). The turntable 262 may be configured to rotate about a vertical axis relative to the chassis 20 to rotate the ladder sections 260 about the vertical axis (e.g., up to 360 degrees, etc.). The ladder sections 260 may rotate relative to the turntable 262 about a substantially horizontal axis to selectively raise and lower the ladder sections 260 relative to the chassis 20. As shown, a water turret or implement, shown as monitor 264, is coupled to a distal end of a fly ladder section 260 (i.e., the most distal of the ladder sections 260). The monitor 264 may be configured to expel water and/or a fire suppressing agent (e.g., foam, etc.) from a water storage tank and/or an agent tank onboard the fire fighting vehicle 250, and/or from an external source (e.g., a fire hydrant, a separate water/pumper truck, etc.). In some embodiments, the ladder assembly 254 further includes an aerial platform coupled to the distal end of the fly ladder section 260 and configured to support one or more operators.

### ARFF Truck

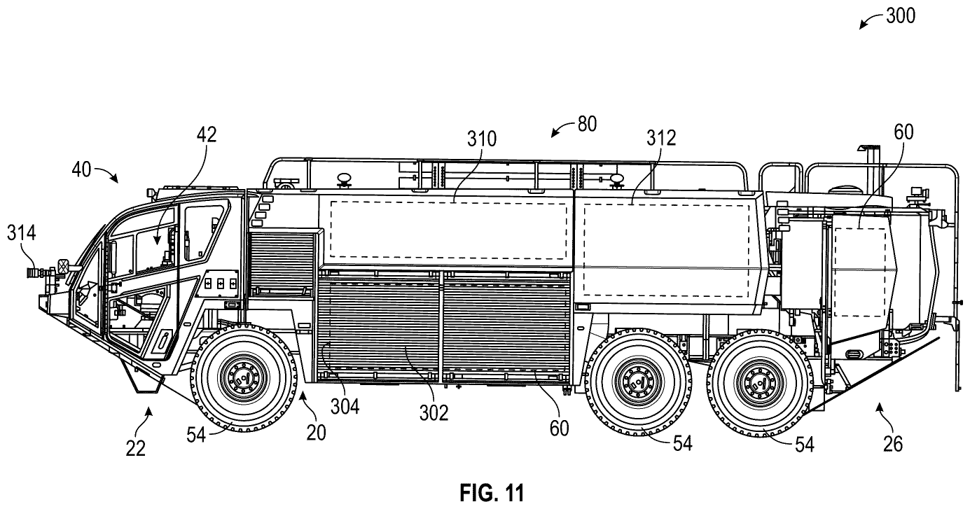

Referring now to FIG. 11, the vehicle 10 is configured as a fire fighting vehicle, shown as airport rescue and fire fighting (ARFF) truck 300. As shown in FIG. 11, the application kit 80 is positioned primarily rearward of the cab 40. As shown, the application kit 80 includes a series of storage compartments or cabinets, shown as compartments 302, that are coupled to the chassis 20. The compartments 302 may store various equipment or components of the ARFF truck 300.

The application kit 80 includes a pump system 304 (e.g., an ultra-high-pressure pump system, etc.) positioned within one of the compartments 302 near the center of the ARFF truck 300. The application kit 80 further includes a water tank 310, an agent tank 312, and an implement or water turret, shown as monitor 314. The pump system 304 may include a high pressure pump and/or a low pressure pump, which may be fluidly coupled to the water tank 310 and/or the agent tank 312. The pump system 304 may to pump water and/or fire suppressing agent from the water tank 310 and the agent tank 312, respectively, to the monitor 314. The monitor 314 may be selectively reoriented by an operator to adjust a direction of a stream of water and/or agent. As shown in FIG. 11, the monitor 314 is coupled to a front end of the cab 40.

### Boom Lift

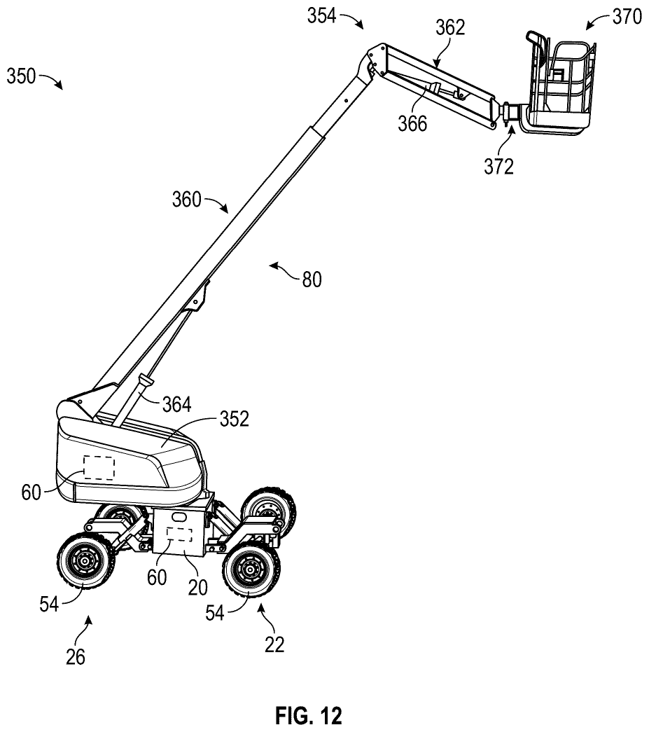

Referring now to FIG. 12, the vehicle 10 is configured as a lift device, shown as boom lift 350. The boom lift 350 may be configured to support and elevate one or more operators. In other embodiments, the vehicle 10 is configured as another type of lift device that is configured to lift operators and/or material, such as a skid-loader, a telehandler, a scissor lift, a fork lift, a vertical lift, and/or any other type of lift device or machine.

As shown in FIG. 12, the application kit 80 includes a base assembly, shown as turntable 352, that is rotatably coupled to the chassis 20. The turntable 352 may be configured to selectively rotate relative to the chassis 20 about a substantially vertical axis. In some embodiments, the turntable 352 includes a counterweight (e.g., the batteries) positioned near the rear of the turntable 352. The turntable 352 is rotatably coupled to a lift assembly, shown as boom assembly 354. The boom assembly 354 includes a first section or telescoping boom section, shown as lower boom 360. The lower boom 360 includes a series of nested boom sections that extend and retract (e.g., telescope) relative to one another to vary a length of the boom assembly 354. The boom assembly 354 further includes a second boom section or four bar linkage, shown as upper boom 362. The upper boom 362 may includes structural members that rotate relative to one another to raise and lower a distal end of the boom assembly 354. In other embodiments, the boom assembly 354 includes more or fewer boom sections (e.g., one, three, five, etc.) and/or a different arrangement of boom sections.

As shown in FIG. 12, the boom assembly 354 includes a first actuator, shown as lower lift cylinder 364. The lower boom 360 is pivotally coupled (e.g., pinned, etc.) to the turntable 352 at a joint or lower boom pivot point. The lower lift cylinder 364 (e.g., a pneumatic cylinder, an electric linear actuator, a hydraulic cylinder, etc.) is coupled to the turntable 352 at a first end and coupled to the lower boom 360 at a second end. The lower lift cylinder 364 may be configured to raise and lower the lower boom 360 relative to the turntable 352 about the lower boom pivot point.

The boom assembly 354 further includes a second actuator, shown as upper lift cylinder 366. The upper boom 362 is pivotally coupled (e.g., pinned) to the upper end of the lower boom 360 at a joint or upper boom pivot point. The upper lift cylinder 366 (e.g., a pneumatic cylinder, an electric linear actuator, a hydraulic cylinder, etc.) is coupled to the upper boom 362. The upper lift cylinder 366 may be configured to extend and retract to actuate (e.g., lift, rotate, elevate, etc.) the upper boom 362, thereby raising and lowering a distal end of the upper boom 362.

Referring still to FIG. 12, the application kit 80 further includes an operator platform, shown as platform assembly 370, coupled to the distal end of the upper boom 362 by an extension arm, shown as jib arm 372. The jib arm 372 may be configured to pivot the platform assembly 370 about a lateral axis (e.g., to move the platform assembly 370 up and down, etc.) and/or about a vertical axis (e.g., to move the platform assembly 370 left and right, etc.).

The platform assembly 370 provides a platform configured to support one or more operators or users. In some embodiments, the platform assembly 370 may include accessories or tools configured for use by the operators. For example, the platform assembly 370 may include pneumatic tools (e.g., an impact wrench, airbrush, nail gun, ratchet, etc.), plasma cutters, welders, spotlights, etc. In some embodiments, the platform assembly 370 includes a control panel (e.g., a user interface, a removable or detachable control panel, etc.) configured to control operation of the boom lift 350 (e.g., the turntable 352, the boom assembly 354, etc.) from the platform assembly 370 or remotely. In other embodiments, the platform assembly 370 is omitted, and the boom lift 350 includes an accessory and/or tool (e.g., forklift forks, etc.) coupled to the distal end of the boom assembly 354.

### Scissor Lift

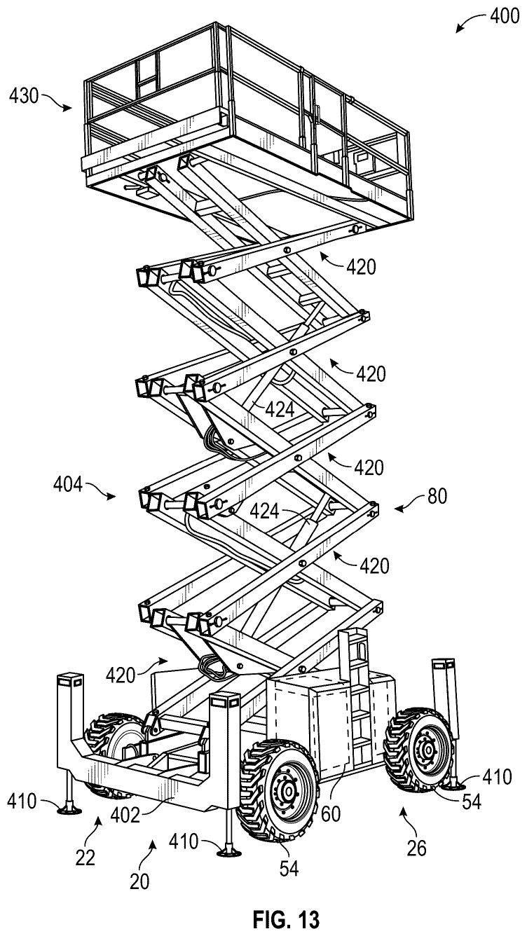

Referring now to FIG. 13, the vehicle 10 is configured as a lift device, shown as scissor lift 400. As shown in FIG. 13, the application kit 80 includes a body, shown as lift base 402, coupled to the chassis 20. The lift base 402 is coupled to a scissor assembly, shown as lift assembly 404, such that the lift base 402 supports the lift assembly 404. The lift assembly 404 is configured to extend and retract, raising and lowering between a raised position and a lowered position relative to the lift base 402.

As shown in FIG. 13, the lift base 402 includes a series of actuators, stabilizers, downriggers, or outriggers, shown as leveling actuators 410. The leveling actuators 410 may extend and retract vertically between a stored position and a deployed position. In the stored position, the leveling actuators 410 may be raised, such that the leveling actuators 410 do not contact the ground. Conversely, in the deployed position, the leveling actuators 410 may engage the ground to lift the lift base 402. The length of each of the leveling actuators 410 in their respective deployed positions may be varied in order to adjust the pitch (e.g., rotational position about a lateral axis) and the roll (e.g., rotational position about a longitudinal axis) of the lift base 402 and/or the chassis 20. Accordingly, the lengths of the leveling actuators 410 in their respective deployed positions may be adjusted to level the lift base 402 with respect to the direction of gravity (e.g., on uneven, sloped, pitted, etc. terrain). The leveling actuators 410 may lift the wheel and tire assemblies 54 off of the ground to prevent movement of the scissor lift 400 during operation. In other embodiments, the leveling actuators 410 are omitted.

The lift assembly 404 may include a series of subassemblies, shown as scissor layers 420, each including a pair of inner members and a pair of outer members pivotally coupled to one another. The scissor layers 420 may be stacked atop one another in order to form the lift assembly 404, such that movement of one scissor layer 420 causes a similar movement in all of the other scissor layers 420. The scissor layers 420 extend between and couple the lift base 402 and an operator platform (e.g., the platform assembly 430). In some embodiments, scissor layers 420 may be added to, or removed from, the lift assembly 404 in order to increase, or decrease, the fully extended height of the lift assembly 404.

Referring still to FIG. 13, the lift assembly 404 may also include one or more lift actuators 424 (e.g., hydraulic cylinders, pneumatic cylinders, electric linear actuators such as motor-driven leadscrews, etc.) configured to extend and retract the lift assembly 404. The lift actuators 424 may be pivotally coupled to inner members of various scissor layers 420, or otherwise arranged within the lift assembly 404.

A distal or upper end of the lift assembly 404 is coupled to an operator platform, shown as platform assembly 430. The platform assembly 430 may perform similar functions to the platform assembly 370, such as supporting one or more operators, accessories, and/or tools. The platform assembly 430 may include a control panel to control operation of the scissor lift 400. The lift actuators 424 may be configured to actuate the lift assembly 404 to selectively reposition the platform assembly 430 between a lowered position (e.g., where the platform assembly 430 is proximate to the lift base 402) and a raised position (e.g., where the platform assembly 430 is at an elevated height relative to the lift base 402). Specifically, in some embodiments, extension of the lift actuators 424 moves the platform assembly 430 upward (e.g., extending the lift assembly 404), and retraction of the lift actuators 424 moves the platform assembly 430 downward (e.g., retracting the lift assembly 404). In other embodiments, extension of the lift actuators 424 retracts the lift assembly 404, and retraction of the lift actuators 424 extends the lift assembly 404.

### Wearable Alert System

### Overview

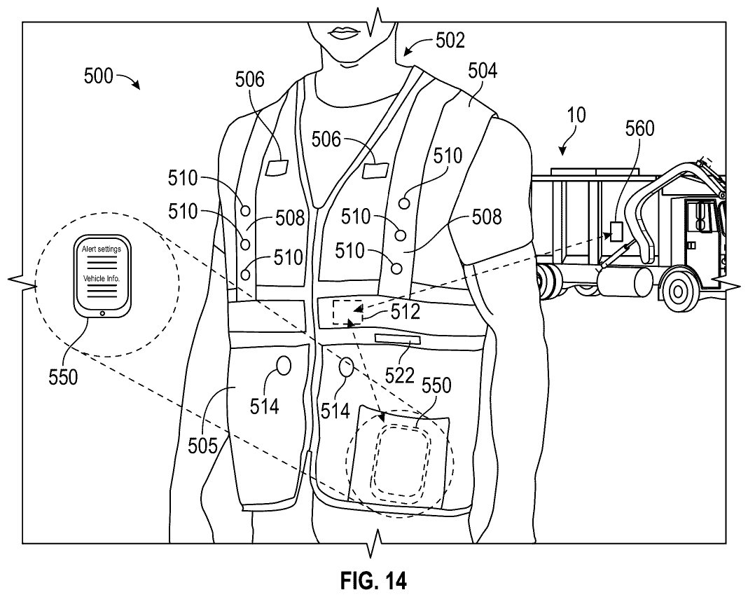

Referring to FIG. 14, an alert system 500 for a user or operator 502 of the vehicle 10 includes a vest, an article of clothing, a wearable device, a wearable system, etc., shown as wearable alert device 504, according to some embodiments. The wearable alert device 504 can be worn by the operator 502 and may have the form of a sweatshirt, a vest, a device that couples to the operator's clothing, a necklace, a jacket, a strap, a belt, etc. In some embodiments, the wearable alert device 504 is a modular unit that can be placed in the operator's 502 pocket, worn as a pendant, secured to an armband, etc.

The wearable alert device 504 includes one or more light emitting diodes (LEDs), condensed fluorescent (CFL) bulbs, glow strips, display screens, etc., shown as visual alert devices 510, according to some embodiments. The visual alert devices 510 can be configured to provide a visual or lighting alert to the operator 502 by varying intensity, color, pattern, etc., of the visual alert devices 510. For example, in response to different conditions or to indicate different alert severities, the visual alert devices 510 can provide green, yellow, or red colors to visually notify the operator 502 regarding an alert and a severity of the alert. The visual alert devices 510 may also flash or blink intermittently to indicate an alert, strobe, actuate brightness or light emittance in a pattern, etc. In some embodiments, the visual alert devices 510 are configured to provide diffused light to provide a glow (e.g., a colored glow) to the operator 502 to notify the operator 502 regarding an alert. The visual alert devices 510 can be arranged in an array, along a specific portion of the wearable alert device 504, etc. In some embodiments, the visual alert devices 510 are arranged along multiple 1-dimensional or 2-dimensional arrays on the wearable alert device 504.

The wearable alert device 504 also includes one or more speakers, sound emitters, electroacoustic transducers, tweeters, beepers, loudspeakers, woofers, sub-woofers, etc., shown as aural alert devices 506, according to some embodiments. The aural alert devices 506 are configured to provide an aural alert to the operator or wearer 502 to notify the operator 502 regarding an alert condition (e.g., a warning event), according to some embodiments. The aural alert devices 506 can provide aural alerts such as tones, siren sounds, spoken words or phrases, a horn sound, etc. The aural alert devices 506 can function in combination with the visual alert devices 510 to notify the operator 502 regarding the alert condition and/or the severity of the alert condition. In some embodiments, a decibel level or loudness of the sounds output by the aural alert devices 506 indicates the severity of the alert condition.

The wearable alert device 504 also includes haptic alert devices 514 that are configured to provide haptic feedback to the operator 502 to notify the operator 502 regarding the alert condition and/or the severity of the alert condition. In some embodiments, the haptic alert devices 514 are configured to vibrate, move, provide a force, accelerate, etc., to provide tactile or haptic feedback to the operator 502 regarding the alert condition or the severity of the alert condition. The haptic alert devices 514 can provide continuous haptic feedback, discrete haptic feedback, etc., to notify the operator 502. The haptic alert devices 514 can be disposed in different locations about the wearable alert device 504 (e.g., proximate the operator's 502 sternum, at the operator's 502 mid-section, at the operator's 502 shoulders, etc.

Referring still to FIG. 14, the wearable alert device 504 includes a controller 512 that is configured to communicate (e.g., wirelessly) with a personal computer device 550 (e.g., a tablet, a smartphone, a handheld device, a remote control, etc.) and a controller 560 of the vehicle 10. The controller 512 may be configured to communicate (e.g., wiredly or wirelessly) with any of the visual alert devices 510, the aural alert devices 506, or the haptic alert devices 514 and provide control signals to the visual alert devices 510, the aural alert devices 506, and/or the haptic alert devices 514 to control the visual alert devices 510, the aural alert devices 506, or the haptic alert devices 514 to provide any combination of visual, aural, or haptic alerts to notify the operator 502 regarding the alert condition and the alert severity. In some embodiments, the controller 512 is configured to obtain instructions from the controller 560 of the vehicle 10 regarding the alert condition or the alert severity. The controller 512 can use the instructions provided by the controller 560 to operate the visual alert devices 510, the aural alert devices 506, and/or the haptic alert devices 514. The controller 512 can also be configured to communicate with the personal computer device 550 to receive updates from the personal computer device 550. In some embodiments, the personal computer device 550 is configured to receive a user input regarding a desired setting for the wearable alert device 504 (e.g., which alert conditions should result in a corresponding type of alert such as visual, aural, or haptic, how the visual, aural, or haptic alerts should be implemented, what severity of the alert condition corresponds to visual, aural, and/or haptic alerts, etc.). The controller 512 may receive the updates or alert settings from the personal computer device 550 and the instructions from the controller 560 and use the updated alert settings and the instructions to determine or select an appropriate alert operation or control of the visual alert devices 510, the aural alert devices 506, or the haptic alert devices 514. In some embodiments, the instructions provided by the controller 560 of the vehicle 10 include a detected alert condition, a severity of the alert condition, or sensor data obtained from sensors of the vehicle 10 that the controller 512 can use to determine if an alert condition is present or proximate, and a corresponding severity of the alert condition. The controller 512 uses the alert condition that is present or proximate in combination with the severity of the alert condition and alert settings (e.g., as provided by the personal computer device 550) to operate the visual alert devices 510, the aural alert devices 506, and/or the haptic alert devices 514 to inform the operator 502 or user regarding the alert condition and the severity of the alert condition.

Referring still to FIG. 14, the wearable alert device 504 includes a positioning device 522 that is configured to monitor or detect a current position of the operator 502 relative to the vehicle 10 (e.g., which side of the vehicle 10 the operator 502 is currently at, how far from the vehicle 10 the operator 502 is currently, etc.) and provide the current position of the operator 502 (or more specifically, the wearable alert device 504) to the controller 512. In some embodiments, the controller 512 uses the current position of the operator 502, in combination with inputs from the personal computer device 550 and inputs from the controller 560 at the vehicle 10 to determine if an alert condition is present, and a severity of the alert condition. In some embodiments, the controller 512 is configured to transmit the current position of the wearable alert device 504 to the controller 560 of the vehicle 10 so that the controller 560 can use the current position to determine if an alert condition is present, and/or to determine a severity of the alert condition that is present. The positioning device 522, the visual alert devices 510, the aural alert devices 506, and the haptic alert devices 514 can be fixedly or removably coupled with the wearable alert device 504, a material or fabric of the wearable alert device 504, a frame or body of the wearable alert device 504, etc., shown as body

### Various Alert Conditions

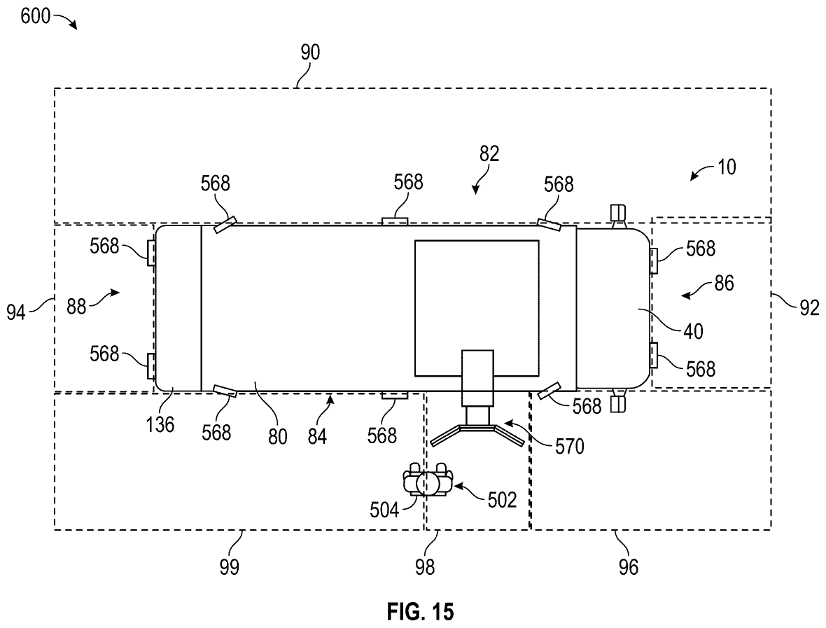

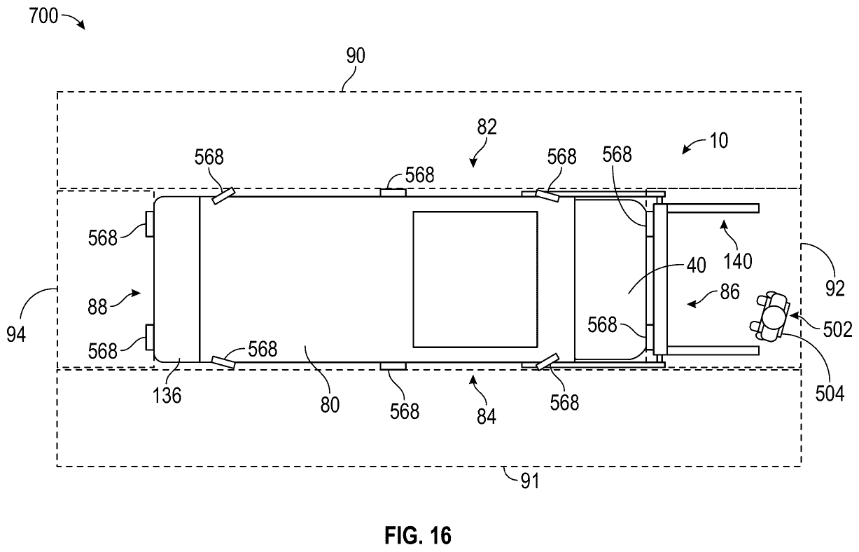

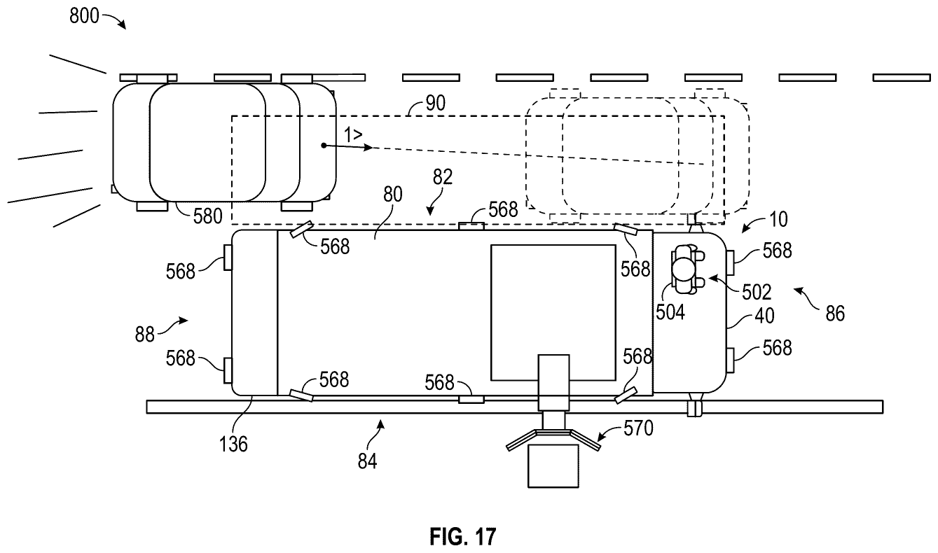

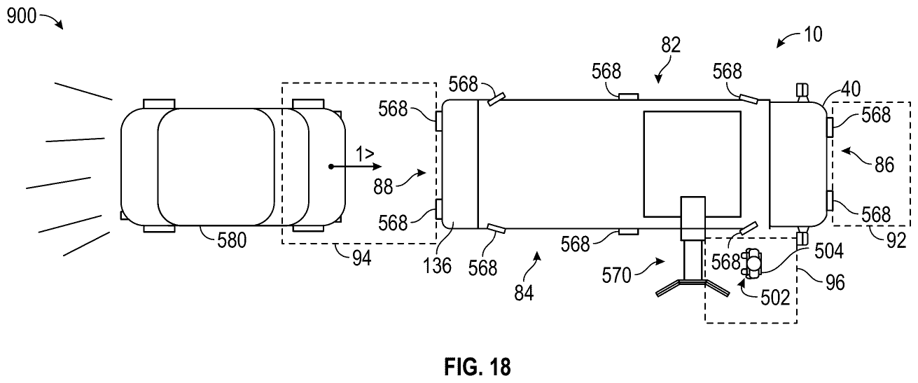

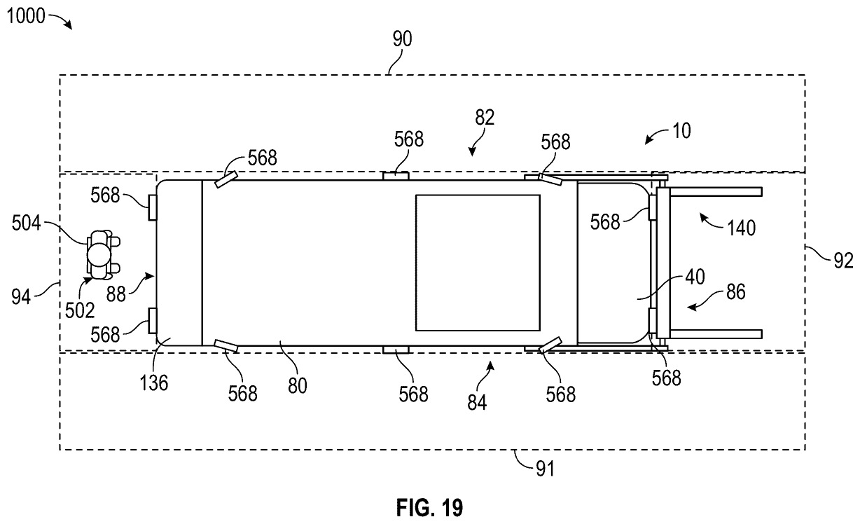

Referring to FIGS. 15-19, illustrations of various alert conditions are shown, according to some embodiments. FIG. 15 illustrates an alert condition when the operator 502 is in a zone 98 and inhibits movement of an automatic side loading (ASL) arm, shown as ASL 570 (e.g., grabber assembly 162). FIG. 16 illustrates an alert condition when the operator 502 is in a zone 92 in front of the vehicle 10. FIG. 17 illustrates an alert condition when the operator 502 is within the cab 40 but should not yet exit the cab 40. FIG. 18 illustrates an alert condition when a collision at the vehicle 10 is imminent. FIG. 19 illustrates an alert condition when the operator 502 is behind the vehicle 10.

Referring particularly to FIG. 15, a diagram 600 illustrates an alert condition when the operator 502 is in the zone 98 across which the ASL 570 (e.g., grabber assembly 162) operates or moves through. The vehicle 10 includes multiple awareness sensors 568 (e.g., cameras, infrared detectors, proximity detectors, wireless signal emitters, radar devices, light detection and ranging (“LIDAR”) devices, etc.) positioned about the vehicle 10. In some embodiments, the awareness sensors 568 are configured to communicate or interact with the positioning device 522 of the wearable alert device 504 to determine the position of the operator 502. In some embodiments, the awareness sensors 568 are configured to detect proximity, motion, type, etc., of other objects that are near the vehicle 10. Specifically, the vehicle 10 includes awareness sensors 568 along a street side 82 (e.g., a left side, a driver's side, etc.), along a curbside 84 (e.g., a right side, a passenger side, etc.), along a front end 86 (e.g., a cab end), and along a rear end 88 (e.g., a tailgate end). The ASL 570 is positioned on the curbside 84 of the vehicle 10 and is configured to removably couple with (e.g., grab, grasp, etc.) a container (e.g., a bin, a garbage can, a receptacle, etc., in which refuse is located), lift the container (e.g., ascend along a track), empty the container into a hopper of the vehicle 10, and return the container to a ground surface. The ASL 570 may be configured to extend in a lateral direction (e.g., outwards) from the curbside 84 of the vehicle 10 so that the ASL 570 can reach containers that are positioned a distance from the curbside 84 of the vehicle 10. The operator 502 is shown partially in the way of the ASL 570, which may frustrate or impair the operation of the ASL 570. Specifically, the operator 502 is shown partially within the zone 98 across which the ASL 570 operates.

The awareness sensors 568 along the street side 82 of the vehicle 10 may be configured to monitor or detect the presence of objects, proximity of objects, motion of objects, etc., that are along the street side 82 of the vehicle 10. In some embodiments, the awareness sensors 568 along the street side 82 of the vehicle 10 are configured to monitor or detect objects, motion, proximity, etc., of objects that are within a street side zone 90. Similarly, the awareness sensors 568 along the rear end 88 of the vehicle 10 can be configured to detect or monitor objects, motion of objects, proximity of objects, etc., that are within a rear zone 94. The awareness sensors 568 along the curb side 84 of the vehicle 10 can be configured to monitor or detect presence, motion, proximity, etc., of objects along the curb side 84 of the vehicle 10 (e.g., within zones 99, 98, and/or 96). The awareness sensors 568 along the front end 86 of the vehicle 10 can be configured to monitor or detect presence, motion, proximity, etc., of objects that are in front of the vehicle 10 (e.g., within a front zone 92). It should be understood that the areas of the front zone 92, the rear zone 94, the street side zone 90, and/or the zones 99, 98, and 96 are illustrative only, and the awareness sensors 568 should not be understood as only being capable of detecting presence, motion, or proximity of objects within these zones.

The position of the operator 502 can be determined or transmitted to the controller 512 or the controller 560 of the vehicle 10 based on data from the positioning device 522, and/or based on data obtained from the awareness sensors 568. In some embodiments, the controller 560 of the vehicle 10 is configured to use a triangulation technique to determine the location or current position of the operator 502 or the wearable alert device 504 relative to the vehicle 10.

When the operator 502 is detected as being within the zone 98, the controller 512 and/or the controller 560 of the vehicle 10 may determine that an alert condition is present. The controller 512 or the controller 560 may determine that the alert condition is present if the operator 502 is within the zone 98, or if the operator 502 is within the zone 98 while the ASL 570 is being requested to operate. In response to the alert condition being present (e.g., the operator 502 being within the zone 98), the controller 512 may operate the visual alert devices 510, the aural alert devices 506, or the haptic alert devices 514 to notify the operator 502 that the alert condition is present, and/or to provide a severity of the alert condition to the operator 502.

In some embodiments, the controller 512 operates the visual alert devices 510 to notify the operator 502 that the operator is currently within the zone 98. The ASL may be communicatively coupled to and controlled by the controller 560 of the vehicle 10. If a command is sent to the controller 560 to operate the ASL 570, both the visual alert devices 510 and the haptic alert devices 514 may be operated to indicate that the severity of the alert condition has increased. Similarly, if the ASL 570 begins to operate, the visual alert devices 510, the haptic alert devices 514, and the aural alert devices 506 may be operated to indicate that severity of the alert condition has increased. In some embodiments, operation of the ASL 570 is limited (e.g., by the controller 560) if the operator 502 is currently within the zone 98.

The alerts provided to the operator 502 may prompt the operator 502 to move out of the zone 98 (e.g., out of the way of the ASL 570) and into zone 99 or into zone 96. Once the operator 502 moves out of the zone 98, the ASL 570 may be operated to perform its intended function. In this way, the wearable alert device 504 can be used to prompt the operator 502 regarding a current alert condition and to prompt the operator 502 to move in order to terminate the alert condition.

Referring to FIG. 16, a diagram 700 illustrates an alert condition when the operator 502 is within the zone 92 in front of the vehicle 10. The vehicle 10 in FIG. 16 is shown implemented as a front end loader 140 (FEL) (e.g., vehicle 100). The vehicle 10 includes the lift assembly 140 that is configured to removably couple with, lift, and empty a container (e.g., a bin, a receptacle, a dumpster, etc.) at the front end 86 of the vehicle 10. The lift assembly 140 is configured to operate within or across the front zone 92. If the operator 502 is within the front zone 92, the controller 512 can operate the visual alert devices 510, the aural alert devices 506, and/or the haptic alert devices 514 in order to notify the operator 502 regarding the alert condition. Similarly to the techniques described in greater detail above with reference to FIG. 15, the controller 512 can operate the visual alert devices 510 when the operator 502 is within the zone 92, operate both the visual alert devices 510 and the aural alert devices 506 when the operator 502 is within the zone 92 and a command is sent to the controller 560 to operate the lift assembly 140, etc. The FEL 140 may be communicatively coupled to and controlled by the controller 560 of the vehicle 10. In some embodiments, operation of the FEL 140 is limited (e.g., by the controller 560) if the operator 502 is currently within the zone 92. Similarly, if the vehicle 10 starts to accelerate or roll forwards towards the operator 502, the controller 512 may operate the visual alert devices 510, the aural alert devices 506, and/or the haptic alert devices 514 to provide a notification to the operator 502 to inform the operator 502 to move to a safer location.

Referring to FIG. 17, a diagram 800 illustrates an alert condition when the operator 502 is within the cab 40, and a vehicle 580 (e.g., an object, a hazard, etc.) is approaching the vehicle 10 along the street side 82 of the vehicle 10 (e.g., from the rear end 88 of the vehicle 10). The vehicle 580, including its current position and velocity, can be identified by the controller 512 or the controller 560 of the vehicle 10 based on sensor data obtained from the awareness sensors 568. The controller 560 can use the sensor data, the current position, and/or the velocity in order to determine or predict a motion vector or path of the vehicle 580 and to determine if the vehicle 580 will be within a particular distance (e.g., a distance that a door of the cab 40 extends outwards when opened) of the street side 82 of the vehicle 10 (or the cab 40) at a future point in time.

If the vehicle 580 is predicted to be within range of the door of the cab 40 at a future point in time (e.g., predicted based on observed motion, speed, etc., as provided by the awareness sensors 568), the controller 512 may operate any of, or a combination of, the visual alert devices 510, the aural alert devices 506, or the haptic alert devices 514. In some embodiments, when the vehicle 580 is approaching but is at a first distance, the controller 512 operates the visual alert devices 510 only in order to notify the operator 502. If the vehicle 580 approaches and is closer and still predicted to be within range of the door of the cab 40 (if opened), the controller 512 may operate the visual alert devices 510 and the haptic alert devices 514. If the vehicle 580 is proximate and approaching the vehicle 10 (e.g., within the zone 90), and the operator 502 reaches to open the door of the cab 40 on the street side 82 of the cab 40, the controller 512 may operate the visual alert devices 510, the haptic alert devices 514, and the aural alert devices 506 to warn the operator 502 to not open the door of the cab 40. In some embodiments, the controller 560 of the vehicle 10 is configured to obtain image data from cameras within the cab 40, to monitor a door sensor, etc., to determine if the operator 502 is about to open the door of the cab 40. In some embodiments, the controller 560 is configured to limit opening of the door of the cab 40 (e.g., lock the doors) so that the operator 502 does not open the door into the oncoming vehicle 10. Once the alert condition (e.g., the vehicle 580) has passed, the controller 512 may operate the visual alert devices 510, the aural alert devices 506, and/or the haptic alert devices 514 to notify the operator 502 that the alert condition has passed and that it is safe to open the door of the cab 40. In this way, the wearable alert device 504 can facilitate providing alerts to the operator 502 for predicted alert conditions.

Referring to FIG. 18, a diagram 900 illustrates an alert condition when the operator 502 is in a position proximate the vehicle 10 and a collision with the vehicle 10 is imminent. As shown in FIG. 18, the vehicle 580 is approaching the rear end 88 of the vehicle 10 and is about to collide with the rear end 88 of the vehicle 10. The operator 502 is standing in front of the ASL 570 in zone 96. If the vehicle 10 is impacted by the vehicle 580, this may result in the entire vehicle 10 shifting forwards, and the operator 502 may be in danger of the ASL 570 moving and hitting the operator 502. The vehicle 580 can be identified based on sensor data obtained from the awareness sensors 568 on the rear end 88 of the vehicle 10. In some embodiments, the controller 560 is configured to determine a current position of the vehicle 580, a current distance between the vehicle 580 and the rear end 88 of the vehicle 10, a current speed at which the vehicle 580 is approaching the rear end 88 of the vehicle 10, and whether or not the vehicle 580 is predicted to stop in time before colliding with the rear end 88 of the vehicle 10. If the controller 560 determines or predicts that the vehicle 580 will collide with the vehicle 10, and the operator 502 is in a location in which the operator 502 is in danger of being contacted by the vehicle 10 or the vehicle 580 during the collision (e.g., in the zone 96 where the operator 502 may be in danger of the ASL 570 contacting the operator 502 during a collision, in zone 92 when the operator 502 may be in danger of being hit by the front end 86 of the vehicle 10 during a collision, or in zone 94 where the operator 502 may be in danger of being hit by the vehicle 580), the controller 512 may operate any of the visual alert devices 510, the aural alert devices 506, and/or the haptic alert devices 514 to notify the operator 502 regarding the imminent, likely, or potential collision so that the operator 502 may move to a safer location.

It should be understood that while FIG. 18 shows an imminent rear-end collision, the techniques described herein may also apply to a front end collision (e.g., warning the operator 502 if a front end collision is imminent and the operator 502 is behind a portion of the vehicle 10), a side collision, etc.

Referring to FIG. 19, a diagram 1000 illustrates an alert condition when the operator 502 is proximate the vehicle 10 at the rear end 88 of the vehicle 10 (e.g., within the rear zone 94). The operator 502 is shown standing in the rear zone 94, and may impede operation of the tailgate 136 of the vehicle 10. If the operator 502 is standing in the rear zone 94 and a request or command is sent to operate the tailgate 136, the controller 512 may operate the visual alert devices 510, the aural alert devices 506, and/or the haptic alert devices 514 to notify the operator 502 that the tailgate 136 is about to be operated and to prompt the operator 502 to move out of the rear zone 94. Similarly, if the vehicle 10 starts to back up or roll backwards towards the operator 502, the controller 512 may operate the visual alert devices 510, the aural alert devices 506, and/or the haptic alert devices 514 to provide a notification to the operator 502 to inform the operator 502 to move to a safer location.

### Control System

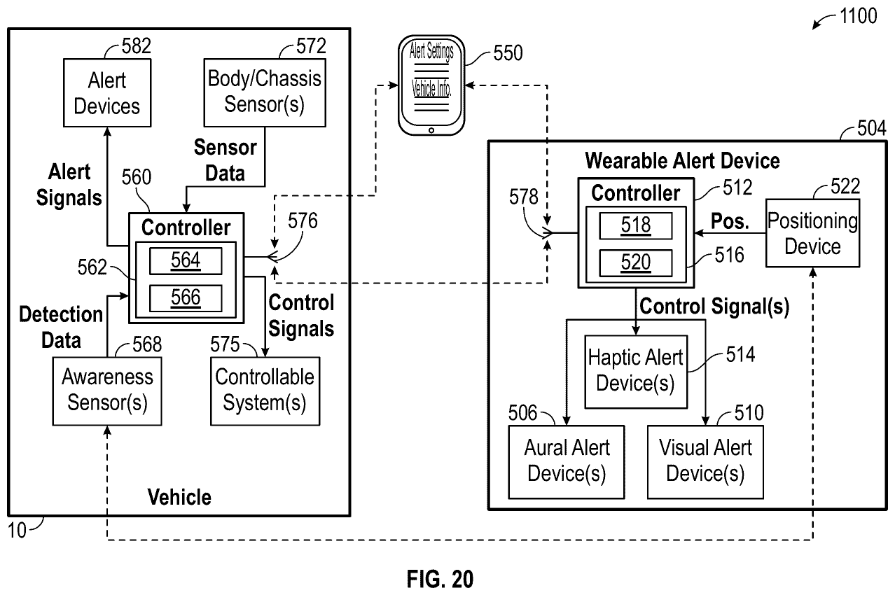

Referring to FIG. 20, a control system 1100 for the vehicle 10 and the wearable alert device 504 includes the wearable alert device 504 and the personal computer device 550. The wearable alert device 504 includes the controller 512 which includes processing circuitry 516, a processor 518, and memory 520. Processing circuitry 516 can be communicably connected to the communications interface such that processing circuitry 516 and the various components thereof can send and receive data via the communications interface. Processor 518 can be implemented as a general purpose processor, an application specific integrated circuit (ASIC), one or more field programmable gate arrays (FPGAs), a group of processing components, or other suitable electronic processing components.

Memory 520 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 520 can be or include volatile memory or non-volatile memory. Memory 520 can include database components, object code components, script components, or any other type of information structure for supporting the various activities and information structures described in the present application. According to some embodiments, memory 520 is communicably connected to processor 518 via processing circuitry 516 and includes computer code for executing (e.g., by processing circuitry 516 and/or processor 518) one or more processes described herein.

In some embodiments, controller 512 is implemented within a single computer (e.g., one server, one housing, etc.). In various other embodiments, the functionality of the controller 512 can be distributed across multiple servers or computers (e.g., that can exist in distributed locations).

Similarly, the controller 560 of the vehicle 10 includes processing circuitry 562, a processor 564, and memory 566. Processing circuitry 562 can be communicably connected to the communications interface such that processing circuitry 562 and the various components thereof can send and receive data via the communications interface. Processor 564 can be implemented as a general purpose processor, an application specific integrated circuit (ASIC), one or more field programmable gate arrays (FPGAs), a group of processing components, or other suitable electronic processing components.

Memory 566 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 566 can be or include volatile memory or non-volatile memory. Memory 566 can include database components, object code components, script components, or any other type of information structure for supporting the various activities and information structures described in the present application. According to some embodiments, memory 566 is communicably connected to processor 564 via processing circuitry 562 and includes computer code for executing (e.g., by processing circuitry 562 and/or processor 564) one or more processes described herein.

In some embodiments, controller 560 is implemented within a single computer (e.g., one server, one housing, etc.). In various other embodiments, the functionality of the controller 560 can be distributed across multiple servers or computers (e.g., that can exist in distributed locations).

The positioning device 522 may be configured to communicate with the awareness sensors 568 so that the awareness sensors 568 can provide the controller 560 with detection data indicating a current position of the operator 502 relative to the vehicle 10. The positioning device 522 may be configured to additionally or alternatively report its current position to the controller 512, which can transmit the position to the personal computer device 550 or the controller 560 via a wireless transceiver 578 (e.g., a wireless radio, a cellular dongle, an ultra-wide band transceiver, etc.) to a wireless transceiver 576 (e.g., a wireless radio, a cellular dongle, an ultra-wide band transceiver, etc.) of the controller 560 of the vehicle 10. If the wireless transceiver 578 is an ultra-wide band transceiver, the wireless transceiver 578 may not need to pair with the controller 512 of the wearable alert device 504, the controller 560, and/or the awareness sensors 568 of the vehicle 10. In some embodiments, the positioning device 522 includes its own wireless transceiver that is configured to communicate with the wireless transceiver 576 of the controller 560 of the vehicle 10 to report its position.

The vehicle 10 also includes one or more body/chassis sensors 572 configured to provide sensor data to the controller 560. The body/chassis sensors 572 can include any speed sensors of the vehicle 10, sensors that measure a current degree of deployment of any of the lift arm actuators 144, the ASL 570, the FEL 140, the tailgate 136, a compaction apparatus of the vehicle 10, a current position of the chute 238, a current position of the turntable 262, a current position or deployment of the ladder assembly 254, etc. In some embodiments, the controller 560 is configured to determine the current positions of any implements of the vehicle 10 (e.g., a current position of the ASL 570, a current position of the FEL 140, a current position of the tailgate 136, etc.). In some embodiments, the controller 560 is also configured to determine or predict a future position of any implement of the vehicle 10 (e.g., a future or predicted position of the ASL 570, a future or predicted position of the FEL 140, a future or predicted position of the tailgate 136, etc.) based on control signals that are provided to any controllable systems 575 of the vehicle 10. The controllable systems 575 can include any of the controllable elements (e.g., linear actuators, electric actuators, electric motors, hydraulics, pneumatics, etc.) of the ASL 570, the FEL 140, the tailgate 136, a compaction apparatus of the vehicle 10, the boom assembly 354, the lift assembly 404, the ladder assembly 254, the turntable 262, etc.

The controller 560, or more particularly, the processing circuitry 562, can use the position of the positioning device 522 (e.g., the position of the wearable alert device 504, the position of the operator 502, etc.), the detection data obtained from the awareness sensors 568, the sensor data obtained from the body/chassis sensors 572, and the control signals provided to the controllable systems 575 that indicate a predicted or future position of any implements of the vehicle 10 to determine if an alert condition is present and to determine a severity or magnitude of the alert condition.

In some embodiments, the controller 560 is configured to provide the determined or identified alert condition and/or the alert severity to the controller 512 of the wearable alert device 504. The controller 512 of the wearable alert device 504 is configured to use the alert condition and the alert severity of the alert condition to determine controls for the haptic alert devices 514, the aural alert devices 506, and the visual alert devices 510 (e.g., which of the haptic alert devices 514, the aural alert devices 506, or the visual alert devices 510 to operate, how to operate the haptic alert devices 514, the aural alert devices 506, or the visual alert devices 510, etc.).

In some embodiments, the alert conditions that are detected by the controller 560 include determining if the operator 502 is about the exit the cab 40 as a vehicle or oncoming traffic is detected by the awareness sensors 568 (e.g., as illustrated in FIG. 17). In some embodiments, the alert conditions that are detected by the controller 560 includes determining if the vehicle 10 is backing up while the operator 502 is within a zone (e.g., the rear zone 94) (as illustrated in FIG. 19). In some embodiments, the alert conditions that are detected by the controller 560 include determining if a parking brake of the vehicle 10 (e.g., as indicated in the sensor data provided by the body/chassis sensors 572) is not set when the operator 502 exits the cab 40. In some embodiments, the alert conditions that are detected by the controller 560 include predicting, based on the detection data provided by the awareness sensors 568, if a rear end collision is expected to occur (e.g., as illustrated in FIG. 18). In some embodiments, the alert conditions that are detected by the controller 560 include determining if a side collision is predicted to occur at the vehicle 10 based on the detection data provided by the awareness sensors 568. In some embodiments, the alert conditions that are detected by the controller 560 include determining if the operator 502 is within a path of the FEL 140, the ASL 570, the tailgate 136, etc., based on the position of the operator 502 or the wearable alert device 504 relative to the vehicle 10. In some embodiments, the alert conditions that are detected by the controller 560 include determining if the operator 502 is in front of the ASL 570 when a rear-end collision is imminent (as illustrated in FIG. 18). In some embodiments, the alert conditions that are detected by the controller 560 include determining if the vehicle 10 is rolling backwards when the operator 502 is rearwards of the vehicle 10 (e.g., in the rear zone 94). Movement of the vehicle 10 can be identified by the controller 560 of the vehicle 10 based on feedback from a sensor of the vehicle 10 such as a sensor or feedback of an electrified axle of the vehicle 10.

In some embodiments, the alert severities include high, medium, and low severities. In some embodiments, certain alert conditions such as expected collisions with the vehicle 10 have a high alert severity. In some embodiments, alert conditions such as when the operator 502 is about to exit the cab 40 and there is incoming traffic, may have a medium severity. In some embodiments, alert conditions such as when the operator 502 is within a zone or within a path of an implement of the vehicle 10 (e.g., within a path or a zone of the ASL 570, within a path or zone of the FEL 140, within a path or zone of the tailgate 136, etc.) may have low or medium alert severity. In some embodiments, the alert severity is a quantified value such as a value between 1 and 10 with 1 being the lowest alert severity and 10 being the highest severity.

In some embodiments, the controller 512 is configured to use the alert condition and the alert severity corresponding to the alert condition to determine how to control the haptic alert devices 514, the aural alert devices 506, the visual alert devices 510. In some embodiments, which of the haptic alert devices 514, the aural alert devices 506, or the visual alert devices 510 are operated by the controller 512 is determined based on the alert severity of the alert condition. For example, high or medium alert severities may include operating the haptic alert devices 514 in combination with the aural alert devices 506 and the visual alert devices 510. In some embodiments, a low alert severity includes operating the visual alert devices 510 and/or the aural alert devices 506 without operating the haptic alert devices 514. In some embodiments, certain low severity alert conditions (such as when the operator 502 is within a zone or in a path of an implement of the vehicle 10 but the implement is not yet being requested to be operated) may be associated with only operating the visual alert devices 510.

In some embodiments, the controller 560 and/or the controller 512 are configured to adjust the alert severity as the alert condition develops in real-time. For example, if there is a low probability of a collision (e.g., the approaching vehicle 10 is far away and may still stop in time), the alert severity may be low, but if the probability of the collision increases (e.g., the approaching vehicle approaches the vehicle 10 and does not slow down, increases in speed, etc.), the controller 560 may increase the alert severity (e.g., to high or medium), and the controller 512 can accordingly operate the haptic alert devices 514, the aural alert devices 506, and/or the visual alert devices 510 to notify the operator 502 that the alert severity has increased. In some embodiments, alert severity may increase based on operation of the vehicle 10, or more specifically, the controllable systems 575 of the vehicle 10 (e.g., the ASL 570, the FEL 140, the tailgate 136, etc.). For example, if the operator 502 is within the zone 98 but the ASL 570 is not yet being operated, the alert severity may be low. However, if the ASL 570 is about to begin to operate or is commanded to operate and the operator 502 is within the zone 98 or in a path of the ASL 570, the alert severity may be increased, updated, modified, etc. (e.g., by the controller 560) to medium or high. The controller 560 provides the updated alert severity of the alert condition to the controller 512, which adjusts operation of the haptic alert devices 514, the aural alert device 506, and/or the visual alert devices 510 to inform the operator 502 regarding the updated alert severity. In some embodiments, the aural alerts provided by the aural alert devices 506 include spoken words or phrases to instruct the operator 502 to move (e.g., a spoken phrase of “Move out of the path of the ASL,” “Warning, please move,” “Please step away from my arm,” “Please move out of the way,” “Collision expected,” “Do not open the door,” “Oncoming traffic!,” etc.).

In some embodiments, the controller 560 is also configured to adjust operation of any of the controllable system 575 based on the alert condition and/or the alert severity. For example, if the operator 502 is standing in the path of one of the implements (e.g., the application kit 80) of the vehicle 10 such as the ASL 570, the FEL 140, the tailgate 136, the chute 238, etc., and a command is sent to the controller 560 to operate the implement such as the ASL 570, the FEL 140, the tailgate 136, the chute 238, etc., the controller 560 may limit operation of the implement until the operator 502 has moved out of the zone or path of the implement. The operator 502 can be prompted to move out of the zone or path of the implement by operation of the haptic alert devices 514, the aural alert devices 506, and/or the visual alert devices 510 by the controller 512. In this way, the controller 512 and the controller 560 can operate cooperatively to both prompt the operator 502 regarding the alert condition, and limiting operation of the vehicle 10 or implements thereof until the alert condition is no longer present (e.g., until the operator 502 moves out of the way of the implement). In some embodiments, the controller 560 is also configured to actively operate the controllable systems 575 to mitigate a hazard. For example, if traffic is oncoming and the operator 502 is about to open the door of the cab 40 into the oncoming traffic, the controller 560 may operate a door lock of the controllable systems 575 to restrict or otherwise limit the operator 502 from opening the door into oncoming traffic, and maintain the door lock of the controllable systems 575 locked until the oncoming traffic passes. In some embodiments, the controller 560 is configured to determine an alert condition if traffic is oncoming and the operator 502 is travelling towards the oncoming traffic. For example, if the operator 502 is in front of the vehicle 10, and a car is oncoming along the street side 82 of the vehicle 10, the controller 560 can determine an alert condition is present if the operator 502 walks towards the street side 82 of the vehicle 10, based on the detection data provided by the awareness sensors 568. In some embodiments, the controller 512 operates the haptic alert devices 514, the aural alert devices 506, and/or the visual alert devices 510 based on the alert condition to notify the operator 502 to be careful due to the oncoming traffic along the street side 82 of the vehicle 10.

In some embodiments, the controller 512 is configured to store (e.g., in the memory 520) a table or database of all different possible alert conditions, and appropriate alert responses for each of the different alert conditions. In some embodiments, the table or database includes corresponding alert severities for each of the different alert conditions and appropriate alert responses for each of the alert conditions and the alert severities. For example, certain conditions, when the alert condition increases from low to medium to high, may have different alert responses, and the controller 512 can adjust operation of the haptic alert devices 514, the aural alert devices 506, and/or the visual alert devices 510 in real-time. In some embodiments, the controller 512 is configured to store the table or database as settings in the memory 520. In some embodiments, the controller 512 stores default or factory settings for operating the haptic alert devices 514, the aural alert devices 506, and/or the visual alert devices 510. In some embodiments, the settings for the operation of the wearable alert device 504 is customizable between different pre-determined modes of operation. For example, the wearable alert device 504 may be transitioned into a silent mode so that the aural alert devices 506 are not operated, and alerts are only provided to the operator 502 via the haptic alert devices 514 and the visual alert devices 510.

Referring still to FIG. 20, the vehicle 10 also includes alert devices 582 (e.g., visual alert devices, aural alert devices, horns, sirens, etc.). In some embodiments, the controller 560 is configured to operate the alert devices 582 to provide a visual alert or an aural alert to the operator 502 cooperatively with the alerts provided to the operator 502 using the wearable alert device 504 (e.g., horns, lights, sirens, etc.). In some embodiments, when the wearable alert devices 504 is transitioned into a silent mode so that the aural alert devices 506 are not operated, the controller 560 is configured to operate the alert devices 582 of the vehicle 10 to provide visual or aural alerts to compensate for the lack of aural alerts provided at the wearable alert device 504. In this way, the alert devices 582 or an alert system of the vehicle 10 can operate cooperatively with the aural alert devices 506, the visual alert devices 510, or the haptic alert devices 514 (e.g., coordinated in color, synchronized, etc.) to provide alerts to the operator 502 for any of the alert conditions described herein. It should be understood that the alert devices 582 can be operated by the controller 560 for any of the alert conditions described herein.

Referring still to FIG. 20, when the operator 502 is outside of the cab 40 of the vehicle 10, the different notification levels or alert severities provided to the operator 502 with the haptic alert devices 514, the aural alert devices 506, and/or the visual alert devices 510 of the wearable alert device 504 can be provided based on a sensitivity or distance at which the potentially dangerous object is detected. For example, when the object is detected at long range (e.g., using the awareness sensors 568 such as long-range radar cameras), the wearable alert device 504 may provide a first notification having a lower tier of warning or a less obtrusive feedback. Similarly, if the object is detected at short range (e.g., using short-range radar), the wearable alert device 504 may provide a second notification having a higher tier of warning or using more obtrusive feedback to indicate the severity of the alert.

### Graphical User Interface

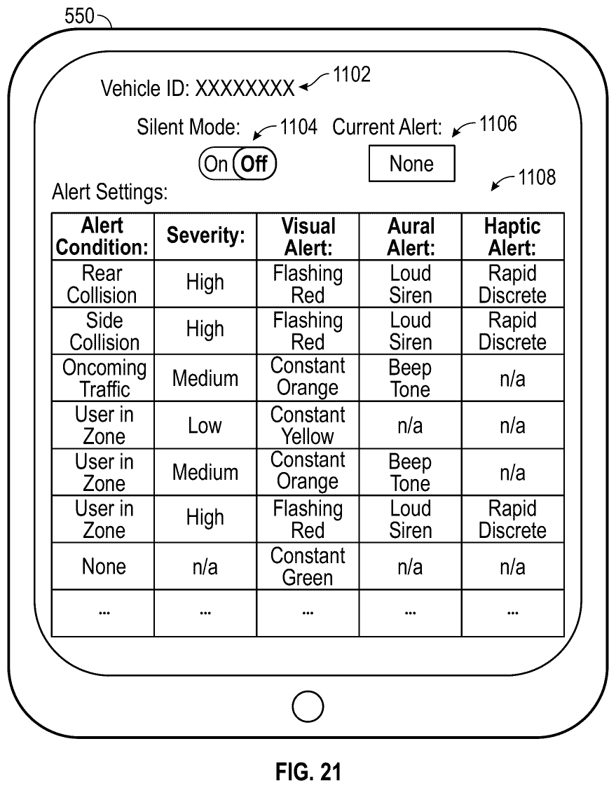

Referring to FIG. 21, the personal computer device 550 can display a vehicle ID 1102, a silent mode selection 1104, a current alert 1106, and alert settings 1108. The vehicle ID 1102 may display an ID of the vehicle 10 with which the personal computer device 550 is currently paired or wirelessly communicably coupled. FIG. 21 shows an example graphical user interface (GUI). The silent mode selection 1104 can be a selectable switch that the operator 502 can switch between on and off to enable or disable the silent mode. When the silent mode is disabled (e.g., the silent mode selection 1104 displays the current selection), the controller 512 does not operate the aural alert devices 506 in response to alert conditions. When the silent mode is enabled, the controller 512 may limit operation of the aural alert devices 506. The current alert 1106 includes a field that displays a current alert condition that is present at the vehicle 10.

The alert settings 1108 are shown displayed as a table that includes the different alert conditions and corresponding severity, and the corresponding visual alert, aural alert, and haptic alert, according to some embodiments. It should be understood that the alert conditions and corresponding alert actions shown in FIG. 21 are illustrative only and should not be understood as being limiting.

The alert conditions are shown to include a predicted rear collision, a predicted side collision, oncoming traffic, several alert conditions for when the user or operator 502 is in a particular zone, and when no alerts are present. It should be understood that these alert conditions are not limiting. The predicted rear collision is shown having a high severity, and the corresponding alert actions include flashing red lights for the visual alert devices 510, providing a loud siren with the aural alert devices 506, and providing rapid discrete haptic feedback using the haptic alert devices 514. The predicted side collision is shown having a high severity, and the corresponding alert actions include flashing red lights for the visual alert devices 510, providing a loud siren with the aural alert devices 506, and providing rapid discrete haptic feedback using the haptic alert devices 514. The oncoming traffic alert condition is shown having a medium severity, and the corresponding alert actions include constant orange lights for the visual alert devices 510, and providing a beep tone with the aural alert devices 506. The first user in the zone alert condition is shown having a low severity, and the corresponding actions include a constant yellow lighting provided via the visual alert devices 510. In some embodiments, the first user in the zone alert condition applies when the operator 502 is determined to be in a particular zone (e.g., the zone 98 as shown in FIG. 15, the zone 94 as shown in FIG. 19, the zone 92 as shown in FIG. 16, etc.). The second user in zone alert condition is shown having a medium severity, and the corresponding visual alert includes providing a constant orange lighting via the visual alert devices 510, and providing a beep tone with the aural alert devices 506. The second user in zone alert condition may apply when the operator 502 is in a zone of an implement or in a path of the implement and the implement is about to operate.

The third user in zone alert condition is shown having a high severity, and the corresponding alerts include providing a flashing red light visual alert using the visual alert devices 510, providing a loud siren using the aural alert devices 506, and providing rapid discrete haptic feedback using the haptic alert devices 514. The third user in zone alert condition may apply when the operator 502 is in the zone of the implement (e.g., in the zone 98 or path of the ASL 570, in the zone 92 or path of the FEL 140, in the zone 94 or path of the tailgate 136, etc.) and the implement is beginning to move.

When no alert condition is present, the controller 512 may operate the visual alert devices 510 to provide green lighting. In some embodiments, the controller 512 only provides the green lighting using the visual alert devices 510 for a certain amount of time after the alert condition has transitioned from a low, medium, or high severity alert condition to no alert condition.

In some embodiments, the operator 502 can select various alert responses (e.g., the responsive visual alerts, the responsive aural alerts, the responsive haptic alerts) and edit, modify, or update the alert responses. For example, the operator 502 may switch the visual alerts, the aural alerts, or the haptic alerts between different predetermined alerts. In some embodiments, one or more of the alert conditions (e.g., the rear collision, side collision, etc., alert conditions) are locked such that the operator 502 is limited from modifying the responsive alert actions. In some embodiments, the personal computer device 550 is configured to provide updated alert settings to the controller 512 when the operator 502 updates the alert settings 1108. In some embodiments, the alert settings 1108 are configured to display updated or different alert settings when the operator 502 enables or disables the silent mode 1104. In some embodiments, enabling the silent mode 1104 causes the personal computer device 550 to display the alert settings 1108 with the aural alerts grayed out.

### Process

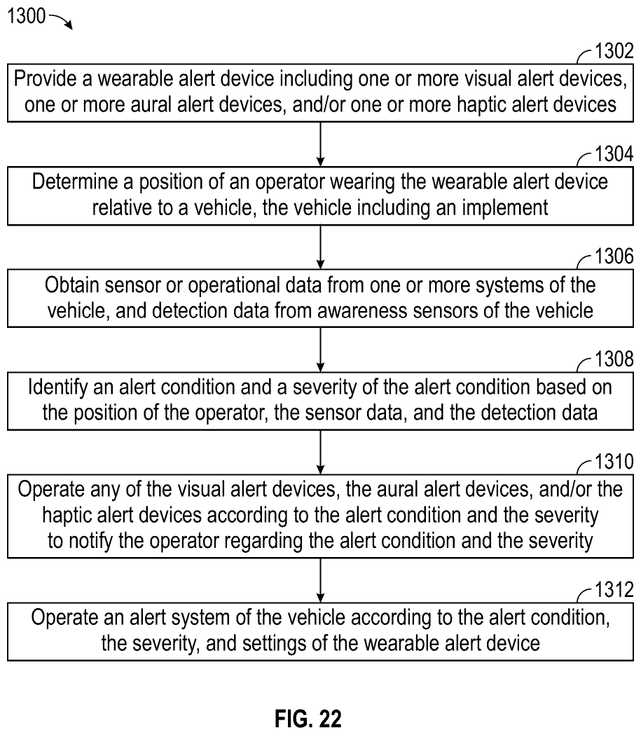

Referring to FIG. 22, a process 1300 for providing alerts to a user of a vehicle regarding alert conditions and severity of the alert conditions is shown, according to some embodiments. Process 1300 includes steps 1302-1312 and can be performed by the control system 1100 (e.g., by the controller 560 and the controller 512). In some embodiments, the vehicle is the vehicle 10. In some embodiments, the vehicle is the refuse vehicle 100, the mixer truck 200, the fire fighting vehicle 250, the ARFF truck 300, the boom lift 350, or the scissor lift 400. In some embodiments, the process 1300 is performed to provide real-time alert feedback to the user to notify the user regarding potentially dangerous conditions, prompt the user to move, etc.

Process 1300 includes providing a wearable alert device including one or more visual alert devices, one or more aural alert devices, and/or one or more haptic alert devices (step 1302), according to some embodiments. In some embodiments, the visual alert devices include LEDs that are configured to emit one or more colors of light (e.g., red, green, blue, or any combination thereof) according to varying intensities, varying patterns, etc. In some embodiments, the aural alert devices include speakers, sirens, beepers, etc. In some embodiments, the haptic alert devices are vibrators or configured to provide tactile or vibrational feedback to the user. The wearable alert device may be the wearable alert device 504. The wearable alert device can also include a positioning device or transmitter that is usable to determine a position of the user. The wearable device may have the form of a vest that is wearable by the user.

Process 1300 includes determining a position of an operator wearing the wearable alert device relative to a vehicle, the vehicle including an implement (step 1304), according to some embodiments. In some embodiments, the positioning device is configured to wirelessly communicate with a controller or different sensors of the vehicle to identify the position of the operator relative to the vehicle. The position of the operator wearing the wearable alert device relative to the vehicle can be provided to a controller of the vehicle and/or a controller of the wearable alert device. In some embodiments, step 1304 includes determining which side of the vehicle the user is on, how close the user is to a side of the vehicle, which of multiple zones surrounding the vehicle that the user is in, etc. In some embodiments, step 1304 is performed by the controller 560 or the controller 512.

Process 1300 includes obtaining sensor or operational data from one or more systems of the vehicle, and detection data from awareness sensors of the vehicle (step 1306), according to some embodiments. In some embodiments, the sensor data includes detection data obtained from one or more cameras, radar cameras, etc., such as the awareness sensors 568, which may detect different objects. In some embodiments, the sensor data includes operational data of any implement, side loading arm, boom arm, telehandler section, etc., indicating a current position, degree of extension, degree of deployment, etc., of the implement, side loading arm, boom arm, telehandler section, etc. In some embodiments, the sensor data includes a current position of the vehicle along a route. In some embodiments, the sensor data indicates environmental objects (e.g., stationary or moving) that surround the vehicle. In some embodiments, the detection data includes camera or image information provided by cameras that are mounted about the vehicle. In some embodiments, step 1306 is performed by the controller 560 of the vehicle 10, or by the controller 512 of the wearable alert device 504.

Process 1300 includes identifying an alert condition and a severity of the alert condition based on the position of the operator, the sensor data, and the detection data (step 1308), according to some embodiments. In some embodiments, the alert condition includes any of detecting if the operator is in a path of an implement of the vehicle, detecting if traffic is oncoming while the operator is in a cab of the vehicle, detecting if traffic is oncoming while the operator is moving to a street side of the vehicle, detecting if a collision is imminent, etc. In some embodiments, the severity of the alert condition is determined based on the type of alert condition that is present. In some embodiments, the detection data is used to determine or identify if a collision is imminent or if traffic is oncoming. In some embodiments, the position of the operator is used to determine the alert condition (e.g., to determine if the operator is standing in a path of the implement) and/or to determine the severity of the alert condition. In some embodiments, step 1308 is performed by the controller 560 or the controller 512.

Process 1300 includes operating any of the visual alert devices, the aural alert devices, and/or the haptic alert devices according to the alert condition and the severity to notify the operator regarding the alert condition and the severity (step 1310), according to some embodiments. In some embodiments, step 1310 includes operating the visual alert devices to provide a lighting alert according to a pattern, a certain color, a certain intensity, etc., to indicate the alert condition and the severity of the alert condition. In some embodiments, step 1310 includes operating the aural alert devices to provide an aural alert such as a beep, a siren, a spoken word or phrase, etc., to notify the operator regarding the alert condition and/or the severity of the alert condition. In some embodiments, step 1310 includes operating the haptic alert devices to provide haptic feedback to the operator to notify the operator regarding the alert condition and/or the severity of the alert condition. In some embodiments, step 1310 is performed by the controller 512 operating the visual alert device 510, the aural alert devices 506, and/or the haptic alert devices 514 based on the alert condition that is detected and the severity of the alert condition.

Process 1300 includes operating an alert system of the vehicle according to the alert condition, the severity, and settings of the wearable alert device (step 1312), according to some embodiments. In some embodiments, step 1312 includes operating a visual alert device or an aural alert device of the vehicle in combination with the wearable alert device. In some embodiments, step 1312 includes operating the alert system of the vehicle to compensate for a silent mode of the wearable alert device. In some embodiments, step 1312 is performed by the controller 560 of the vehicle 10 and the alert device 582 of the vehicle 10.

### Different Implementations

Referring to FIGS. 14 and 1, 3-5, 6-8, and 9-13, the wearable alert device 504 is usable with any of the vehicle 10, the refuse vehicle 100, the mixer truck 200, the fire fighting vehicle 250, the ARFF 300, the boom lift 350, the scissor lift 400, etc. In some embodiments, for any of the vehicle 10, the refuse vehicle 100, the mixer truck 200, the fire fighting vehicle 250, the ARFF 300, the boom lift 350, or the scissor lift 400 the functionality as described with reference to the collision alert conditions as detected by the awareness sensors 568 may be performed substantially the same. Similarly, the vehicle 10, the refuse vehicle 100, the mixer truck 200, the fire fighting vehicle 250, and the ARFF 300 each include a cab compartment and therefore the techniques described herein with reference to the detection of oncoming traffic, corresponding alerts, and limiting opening of the door may be applied substantially the same as described in greater detail above. In some embodiments, the techniques described herein for identifying alert conditions and alerting the operator when the operator is in a zone or a path of the implement of the vehicle can similarly be applied. For example, if the wearable alert device 504 is used with the mixer truck 200, the chute 238 may be treated as the implement, if the wearable device 504 is used with the fire fighting vehicle 250, the ladder assembly 254 may be treated as the implement, if the wearable device 504 is used with the boom lift 350, the boom assembly 354 may be treated as the implement, etc. In this way, the vehicle 10 as described in greater detail above with reference to FIGS. 14-21 is described as a refuse vehicle (e.g., having an ASL or an FEL or a tailgate) but may be any other vehicle as described herein.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

1. A system for alerting a user of a refuse vehicle comprising:
a wearable alert device configured to be worn by the user of the refuse vehicle, the wearable alert device comprising at least one of:
a visual alert device configured to provide visual feedback to the user;
an aural alert device configured to provide aural feedback to the user; and
a haptic alert device configured to provide haptic feedback to the user;
a positioning device coupled to the wearable alert device and configured to determine a current position of the user; and
processing circuitry configured to:
obtain, from the positioning device, the current position of the user;
obtain, from the refuse vehicle, sensor data obtained from one or more sensors of the refuse vehicle, wherein the sensor data is indicative of a vehicle proximate the refuse vehicle;
predict a collision of the vehicle with the refuse vehicle based at least in part on the sensor data;
determine, based on the current position of the user and the predicted collision, whether the user is currently within a predicted path of an implement of the refuse vehicle during the collision, the vehicle during the collision, or the refuse vehicle during the collision;
determine an alert condition and a severity of the alert condition based at least in part on the sensor data obtained from the one or more sensors of the refuse vehicle, the current position of the user, and on the determination of whether the user is currently within the predicted path of the implement of the refuse vehicle during the collision, the vehicle during the collision, or the refuse vehicle during the collision; and
operate at least one of the visual alert device, the aural alert device, or the haptic alert device to provide visual feedback, aural feedback, or haptic feedback to the user to inform the user regarding the alert condition and the severity of the alert condition.

2. The system of claim 1, wherein the wearable alert device is a vest or an article of clothing.

3. The system of claim 1, wherein the processing circuitry is further configured to:
determine the alert condition and the severity of the alert condition at least in part based on the determination that the user is currently within the predicted path of the implement of the refuse vehicle.

4. The system of claim 3, wherein the implement of the refuse vehicle comprises an automated side-loaded arm, a front-end loader, a tailgate, a mixer chute, a ladder assembly, or a boom assembly.

5. The system of claim 1, wherein the processing circuitry is configured further to:
upon determining the alert condition is of high severity, operate the visual alert device to provide visual feedback, operate the aural alert device to provide aural feedback, and operate the haptic alert device to provide haptic feedback to inform the user of the high severity of the alert condition;
upon determining the alert condition is of medium severity, operate the visual alert device to provide visual feedback and operate the aural alert device to provide aural feedback to inform the user of the medium severity of the alert condition; and
upon determining the alert condition is of low severity, operate the visual alert device to provide visual feedback to inform the user of the low severity of the alert condition.

6. A method for alerting a user of a refuse vehicle regarding an alert condition, the method comprising:
obtaining, from a positioning device, a current position of the user of the refuse vehicle;
obtaining, from the refuse vehicle, sensor data obtained from one or more sensors of the refuse vehicle, wherein the sensor data is indicative of a vehicle proximate the refuse vehicle;
predict a collision of the vehicle with the refuse vehicle based at least in part on the sensor data;
determining based on the current position of the user of the refuse vehicle and the predicted collision, whether the user is currently within a predicted path of an implement of the refuse vehicle during the collision, the vehicle during the collision, or the refuse vehicle during the collision;
determining the alert condition and a severity of the alert condition based at least in part on the sensor data obtained from the one or more sensors of the refuse vehicle, the current position of the user, and on the determination of whether the user is currently within the predicted path of the implement of the refuse vehicle during the collision, the vehicle during the collision, or the refuse vehicle during the collision; and
operating at least one of a visual alert device to provide visual feedback, an aural alert device to provide aural feedback, or a haptic alert device to provide haptic feedback to the user to inform the user regarding the alert condition and the severity of the alert condition.

7. The method of claim 6, wherein the visual alert device, the aural alert device, or the haptic alert device is provided on a vest or article of clothing that is worn by the user.

8. The method of claim 6, further comprising:
determining the alert condition and the severity of the alert condition at least in part based on the determination that the user is currently within the predicted path of the implement of the refuse vehicle.

9. The method of claim 8, wherein the implement of the refuse vehicle comprises and automated side-loading arm, a front-end loader, a tailgate, a mixer chute, a ladder assembly, or a boom assembly.

10. The method of claim 6, further comprising:
upon determining the alert condition is of high severity, operating the visual alert device to provide visual feedback, operating the aural alert device to provide aural feedback, and operating the haptic alert device to provide haptic feedback to inform the user of the high severity of the alert condition;
upon determining the alert condition is of medium severity, operating the visual alert device to provide visual feedback and operating the aural alert device to provide aural feedback to inform the user of the medium severity of the alert condition; and
upon determining the alert condition is of low severity, operating the visual alert device to provide visual feedback to inform the user of the low severity of the alert condition.

11. A wearable alert device comprising:
an article of clothing with at least one of;
a visual alert device provided on the article of clothing, configured to provide visual feedback to a user;
an aural alert device provided on the article of clothing, configured to provide aural feedback to the user; or
a haptic alert device provided on the article of clothing, configured to provide haptic feedback to the user;
a positioning device coupled to the wearable alert device and configured to determine a current position of the user; and
processing circuitry configured to:
obtain, from the positioning device, the current position of the user;
obtain, from a refuse vehicle, sensor data obtained from one or more sensors of the refuse vehicle, wherein the sensor data is indicative of a vehicle proximate the refuse vehicle;
predict a collision of the vehicle with the refuse vehicle based at least in part on the sensor data;
determine, based on the current position of the user of the refuse vehicle and the predicted collision, whether the user is currently within a predicted path of an implement of the refuse vehicle during the collision, the vehicle during the collision, or the refuse vehicle during the collision;
determine an alert condition and a severity of the alert condition based at least in part on the sensor data obtained from the one or more sensors of the refuse vehicle, the current position of the user, and on the determination of whether the user is currently within the predicted path of the implement of the refuse vehicle during the collision, the vehicle during the collision, or the refuse vehicle during the collision; and
operate at least one of the visual alert device, the aural alert device, or the haptic alert device to provide visual feedback, aural feedback, or haptic feedback to the user to inform the user regarding the alert condition and the severity of the alert condition.

12. The wearable alert device of claim 11, wherein the article of clothing is a vest.

13. The wearable alert device of claim 11, wherein the processing circuitry is further configured to:
determine the alert condition and the severity of the alert condition at least in part based on the determination that the user is currently within the predicted path of the implement of the refuse vehicle.

14. The wearable alert device of claim 11, wherein the processing circuitry is further configured to:
upon determining the alert condition is of high severity, operate the visual alert device to provide visual feedback, operate the aural alert device to provide aural feedback, and operate the haptic alert device to provide haptic feedback to inform the user of the high severity of the alert condition;
upon determining the alert condition is of medium severity, operate the visual alert device to provide visual feedback and operate the aural alert device to provide aural feedback to inform the user of the medium severity of the alert condition; and
upon determining the alert condition is of low severity, operate the visual alert device to provide visual feedback to inform the user of the low severity of the alert condition.
